(19) United States
(12) Patent Application Publication
(10) Pub. No.: US 2013/0228136 A1
(43) Pub. Date: Sep. 5, 2013

(54) LIQUID DISPENSER

(71) Applicants: AIRCOM MANUFACTURING, INC., Indianapolis, IN (US); ELI LILLY & COMPANY, Indianapolis, IN (US)

(72) Inventors: Gregory A. Lyon, Indianapolis, IN (US); Mick A. Trompen, Westfield, IN (US); Ronald W. Lyon, Noblesville, IN (US); Joseph R. Winkle, Carmel, IN (US); Kevin Willard, Indianapolis, IN (US)

(21) Appl. No.: 13/864,910

(22) Filed: Apr. 17, 2013

Related U.S. Application Data
(63) Continuation of application No. PCT/US2011/056897, filed on Oct. 19, 2011.
(60) Provisional application No. 61/394,616, filed on Oct. 19, 2010.

(51) Int. Cl. A01K 13/00

(52) U.S. Cl. CPC A01K 13/003
USPC 119/601; 222/82; 222/323; 222/153.13

(57) ABSTRACT

A method of dispensing liquid from a dispenser onto an animal. The method includes placing a tip of the dispenser on or near the skin of the animal and depressing a plunger which is movably disposed in a body of the dispenser. Depressing the plunger causes a membrane in the body to be pierced such that an opening is formed in the membrane. At least some of the liquid is dispensed through an opening of the dispenser onto the skin of the animal. In another embodiment, a dispenser is provided for dispensing liquid onto the skin of an animal. The dispenser can include a cap and a replaceable cartridge.

### RELATED APPLICATIONS

This is a Continuation Application of PCT/US2011/056897, filed Oct. 19, 2011, which claims priority to U.S. Provisional Patent Application Ser. No. 61/394,616, filed Oct. 9, 2010, both of which are incorporated herein in their entirities.

### BACKGROUND

The present invention relates to a liquid dispenser, and in particular, to a liquid dispenser and method of using the liquid dispenser to treat domestic animals against fleas, ticks, and other pests.

Routine care of a domestic animal generally includes treating the animal against fleas, ticks, and other insects. Fleas can be carriers for worms and various diseases, whereas ticks are the most significant anthropod in transmitting diseases to domestic animals. Unlike fleas, ticks can directly cause a disease or illness in an animal. Ticks are responsible for anemia due to blood loss, dermatosis due to salivary secretions, and ascending tick paralysis due to neurotoxins in the salivary secretions. While ticks remain primarily outdoors, fleas can enter a dwelling and cause problems to an animal both indoors and outdoors.

As a result, there have been many different preventative measures developed for protecting a domestic animal against fleas, ticks, and other pests. One such example is a flea or tick collar. The collar is worn around the animal's neck, but in the case of the flea collar, some researchers suggest the collar is ineffective towards preventing fleas. See www.k9web.com. Other preventative measures can include spraying chemicals both indoors and outdoors to kill fleas and/or flea larvae. However, some chemicals have very low toxicity such that only flea larvae are killed, but adult fleas are unaffected. Another preventative measure is bathing a domestic animal with a flea-killing substance to remove any fleas presently residing on the body of the animal. While “dipping” the animal in the flea-killing substance can cure an immediate flea problem, it does not protect the animal against future flea or tick problems. Other preventative measures include powders and other chemicals that may be applied to an indoor carpet or upholstery, for example, that kill fleas or prevent indoor flea infestations.

Another common preventative measure is a substance that is topically applied to the domestic animal. Examples include Advantage® from Bayer Corporation, Frontline® from Merial, Ltd., Knockout® from Virbac AH, Inc., and BioSpot® from Farnam Companies, Inc. The substances are liquids which are applied to the skin of an animal and can kill fleas or ticks on contact. Research has shown that such substances can be selectively toxic to other insects and serve as both a repellant and insecticide. See www.k9web.com. The substances work by disrupting the flea's nervous system and kill up to 100% of existing fleas within 24 hours of application and continue killing fleas for up to 3 months for dogs and 6 weeks for cats. See http://frontline.us.merial.com/products/products_flplus.asp.

While the substances discussed above have proven effective at controlling fleas and ticks on domestic animals, conventional dispensers used for applying the substances are difficult to use. Before applying one of these substances to the animal, the user must first use scissors or another cutting tool to remove an outer package to access a sealed dispenser in which the substance is contained. To access the substance, one end of the sealed dispenser must be bent along a fold. The bent end can be broken away from the remainder of the sealed dispenser or it can remain attached at the fold. Once the one end is bent, however, the substance is free to flow out of the dispenser and be topically applied to the skin of the animal.

One problem with this type of known dispenser is the difficulty of simultaneously handling both the dispenser and the animal to be treated. In the case of larger animals, it often takes one person to hold the animal and a second person using both hands to topically apply the substance. If a person attempts to apply the substance alone, the difficulty in maneuvering the dispenser with one hand and maintaining the animal in place with the other often results in some, if not all, of the substance being spilled on the floor or on the person applying it instead of reaching the animal's skin.

As just alluded, another problem with the conventional dispenser is that the user may come into direct contact with the substance. For example, once the end of the dispenser is bent, the substance is free to flow out of the dispenser. If the user is not careful when handling the dispenser, the substance may leak from the open end onto the user's body or clothing.

Also, some animals have heavy coats with large amounts of fur, e.g., a “double coat,” that prevent or block the substance from being applied to the animal's skin. In such instances, the user may have to rub the substance into the animal's fur so that the substance reaches the skin. Again, in this case, the user's skin or clothing comes into direct contact with the substance and this can pose a health risk to the user, especially if the user does not thoroughly wash their skin or clothing after use. Any direct or indirect contact with the substance can be dangerous. Unfortunately, conventional dispensers are not designed to completely eliminate contact with the substance.

Thus, what is needed is a liquid dispenser and method of using the dispenser that allows an individual to topically apply a substance to a domestic animal and reduces or eliminates the possibility of the individual being contaminated with the substance.

### SUMMARY

The present invention provides an apparatus for and a method of dispensing liquid from a dispenser onto an animal. The dispenser has a body that defines a chamber in which liquid is held and a plunger movably disposed in the body. In use, a tip of the dispenser is placed on or near the skin of the animal. The plunger is depressed such that gas located in the chamber is compressed. As the plunger is depressed, the plunger pierces a membrane in the body and forms an opening in the membrane. At least some of the liquid held in the chamber is dispensed through an opening of the dispenser onto the skin of the animal.

In one form thereof, a method of dispensing a liquid from a dispenser onto an animal is provided. The dispenser has a body that defines a chamber in which liquid is held and a plunger that is movably disposed in the body. The method includes gripping the dispenser with one hand and placing a tip of the dispenser on or near the skin of the animal. A latch of the dispenser can be unlocked by the one hand, which thereby frees the plunger. The plunger can be depressed with the one hand such that at least some of the liquid dispenses through an opening of the dispenser. A second hand can then be used for holding the animal as the user handles the dispenser and dispenses the liquid onto the skin of the animal.

In a different embodiment, a liquid dispenser is provided which includes a hollow body having a membrane and a grip member. The liquid dispenser also includes a finger-actuable plunger that is movably disposed in the body such that movement of the plunger pierces the membrane and creates an opening in the membrane for liquid to exit the dispenser. A finger actuable latch is movably coupled to the body and positioned near the finger actuable plunger. Movement of the latch releases the plunger for movement. The finger actuable latch can prevent accidental discharge of the liquid and also serves as a child-resistant mechanism.

These embodiments are advantageous because the dispenser can be handled by an individual using only one hand. The finger actuable latch can be released by the same hand that depresses the plunger for dispensing the liquid. This frees the user's other hand for holding the animal when dispensing the liquid onto the animal's skin. The dispenser also provides a tactile sensation to the user when the liquid is dispensed. For example, as the user moves the plunger through the body, the membrane in the body offers resistance to the plunger's movement. The user is able to feel this resistance, and by applying more force to the plunger, the plunger can pierce through the membrane, thereby creating an opening therein for liquid to exit the dispenser.

In another embodiment, a method of manufacturing a dispenser is provided. The method includes providing a dispenser body having a chamber and adding liquid to the chamber. A plunger is inserted into the chamber and a substantially airtight seal is formed between the chamber and plunger. The plunger is held at a desired depth within the chamber and a releasable latch engages the plunger to hold the plunger in place until use.

In an advantageous embodiment, a liquid dispenser is provided and includes a hollow body having a grip member and a cap coupled to one end of the body. The cap defines a dispensing opening at an end thereof opposite the body. The dispenser also includes a cartridge having a membrane and which is removably disposed in the cap. A finger-actuable plunger is movably disposed in the body such that movement of the plunger pierces the membrane and creates an opening in the membrane for liquid to exit the dispenser. In one form of this embodiment, the cartridge can be replaceable such that, after a single use, the used cartridge is removed and a new cartridge is inserted into the cap. Advantageously, a user can reuse the dispenser repeatedly without having to purchase another dispenser. Instead, the user only replenishes the cartridge, which provides a more economical and environmentally-friendly dispenser.

Likewise, an embodiment which includes a method of using the liquid dispenser is provided. The method includes placing a tip of the cap on or near the skin of the animal and depressing the plunger. When the plunger is depressed, air or gas located in a reservoir defined in the cartridge is compressed. Movement of the plunger pierces the membrane in the cartridge and creates an opening in the membrane. The method further includes dispensing at least some of the liquid through a dispensing opening of the cap onto the skin of the animal. Again, the method can include replacing the used cartridge with a new cartridge. To do so, the cap is decoupled from the body and the used cartridge is removed from the cap. A new cartridge can be inserted into the cap and the cap can then be recoupled to the body. The dispenser is then ready for use.

In one form of another exemplary embodiment, a liquid dispensing system is provided. The system includes a dispenser and a plurality of cartridges. The dispenser comprises a hollow body having a grip member and a cap coupled to one end of the body. The cap defines a dispensing opening at an end opposite the body. The dispenser also includes a plunger that is movably disposed in the body. Each of the plurality of cartridges has a membrane. The plurality of cartridges is removably and interchangeably received in the cap.

In another form thereof, the system includes a dispenser and a plurality of caps. The dispenser comprises a hollow body and a plunger movably disposed in the body. The body has a grip member. Each of the plurality of caps defines a dispensing opening at one end thereof. Also, a membrane is disposed in each cap. The plurality of caps is removably and interchangeably coupled to one end of the body.

Advantageously, the present invention provides an easy-to-use liquid dispenser for topically applying a liquid onto the skin of a domestic animal that requires only one hand of the user to handle and dispense the liquid while freeing the user's other hand to hold the animal.

Another advantage is that the stream or spray that is dispensed from the dispenser is driven at high speed to the skin of the animal instead of being merely topically applied. This provides promotes the medication in reaching its intended location, namely, the skin of the animal, which is especially advantageous with double coated animals.

### BRIEF DESCRIPTION OF THE DRAWINGS

The above-mentioned aspects of the present invention and the manner of obtaining them will become more apparent and the invention itself will be better understood by reference to the following description of the embodiments of the invention, taken in conjunction with the accompanying drawings, wherein:

FIG. 1A is a perspective view of a conventional dispenser topically dispensing a liquid onto a domestic animal;

FIG. 1B is a perspective view of the conventional dispenser of FIG. 1A in which the liquid is shown having been undesirably discharged onto the body of the user;

FIG. 2A is a perspective view of a liquid dispenser in accordance with an embodiment of the present invention topically dispensing a liquid onto a domestic animal;

FIG. 2B is a close-up perspective view of the liquid dispenser of FIG. 2A;

FIG. 3 is an exploded front-elevational view of an embodiment of a liquid dispenser;

FIG. 3A is a cross-sectional view of one embodiment of a plunger of the liquid dispenser of FIG. 3 taken along lines 3A-3A;

FIG. 3B is a cross-sectional view of a second embodiment of a plunger of the liquid dispenser of FIG. 3 taken along lines 3B-3B;

FIG. 4A is a perspective view of a liquid dispenser with a finger actuable latch moved to a release position;

FIG. 4B is a perspective view of the liquid dispenser of FIG. 4A with its plunger partially depressed into contact with a membrane;

FIG. 4C is a perspective view of the liquid dispenser of FIG. 4B with the plunger having pierced the membrane to dispense a liquid;

FIG. 5 is a perspective view of a liquid dispenser in a fully depressed position;

FIG. 6A is a perspective view of a liquid dispenser with a different embodiment of a finger actuable latch;

FIG. 6B is a perspective view of the liquid dispenser of FIG. 6A with the finger actuable latch removed and the plunger depressed;

FIG. 7 is a perspective view of another embodiment of a liquid dispenser;

FIG. 8 is an exploded view of the liquid dispenser of FIG. 7;

FIGS. 9a and 9b are cross-sectional views of the liquid dispenser of FIG. 7 in a before dispensing position, with FIG. 9a showing the cap not yet installed on the dispenser;

FIG. 10 is a cross-sectional view of the liquid dispenser of FIG. 7 in a dispensed position;

FIG. 11 is an exploded view of an alternative embodiment of a liquid dispenser;

FIG. 12 is a cross-sectional view of the liquid dispenser of FIG. 11 in a before dispensing position;

FIG. 13 is a cross-sectional view of the liquid dispenser of FIG. 11 in a dispensed position; and

FIG. 14 is a perspective view of a disposable cap for a liquid dispenser;

FIG. 15a is a partial cross-sectional perspective view of the disposable cap of FIG. 14;

FIG. 15b is a partial cross-sectional perspective view of an alternate embodiment of the disposable cap of FIG. 14

FIG. 16 is a perspective view of the disposable cap of FIG. 14 coupled to a liquid dispenser; and

FIG. 17 is a perspective view of the disposable cap of FIG. 14 disassembled from the liquid dispenser.

Corresponding reference numerals are used to indicate corresponding parts throughout the several views.

### DETAILED DESCRIPTION

The embodiments of the present invention described below are not intended to be exhaustive or to limit the invention to the precise forms disclosed in the following detailed description. Rather, the embodiments are chosen and described so that others skilled in the art may appreciate and understand the principles and practices of the present invention.

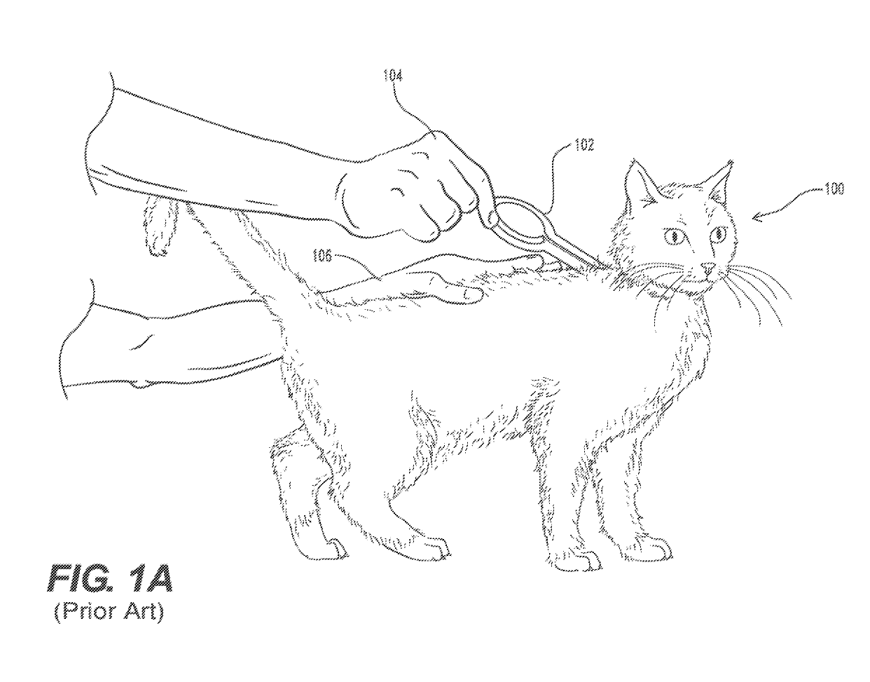

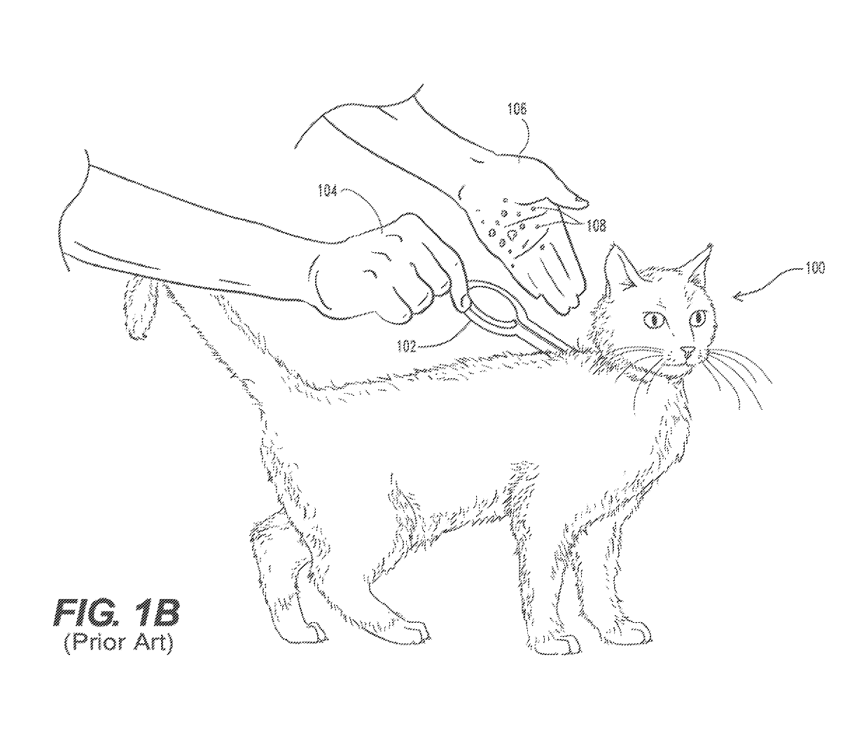

With reference to FIGS. 1A and 1B, a conventional dispenser 102 for topically applying a flea or tick control substance to an animal 100 is provided. The conventional dispenser 102 is shown being held by one hand 104 of the user while a second hand 106 holds the animal 100. Other conventional dispensers may require the user to hold the dispenser with both hands, thereby requiring a second person to hold the animal. Alternatively, the animal may be large and therefore require the presence of a second person. Nevertheless, in FIG. 1B, the user's second hand 106 is shown with the control substance 108 having leaked or come into contact with the hand 106. Conventional dispensers, including the one shown in FIGS. 1A and 1B, can leak or otherwise come into contact with the user's body or clothing. This is one of several disadvantages associated with conventional dispensers.

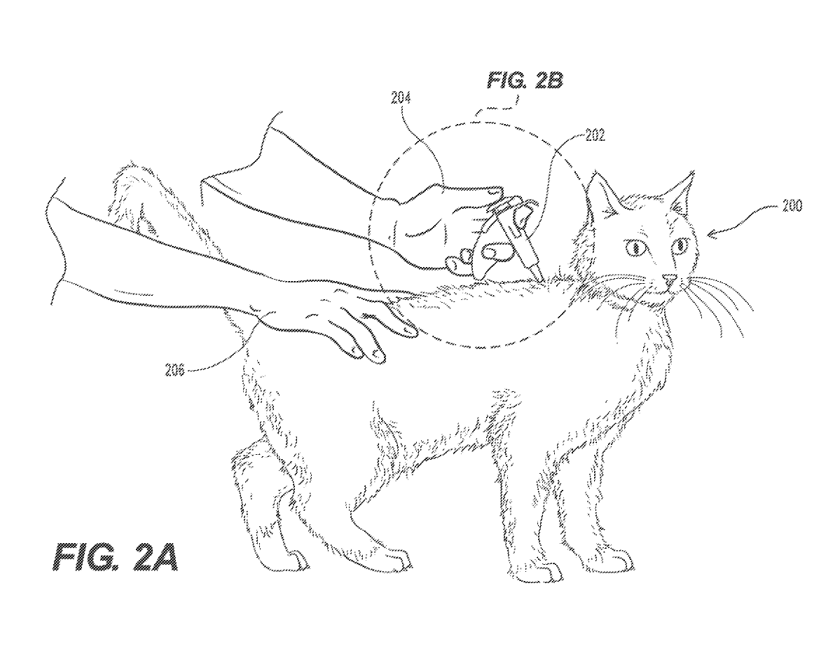

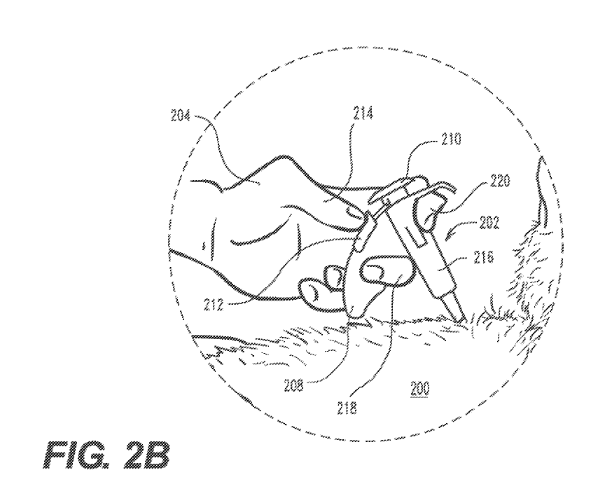

With reference to FIG. 2A, an exemplary embodiment of a dispenser is shown. The dispenser 202 is being held by one hand 204 of a user to topically apply a liquid to an animal 200. The user's second hand 206 is available to hold the animal 200 while the liquid is being dispensed thereon.

As shown in FIG. 2B, the dispenser 202 includes a body 216, plunger 210, and safety latch 212. The dispenser 202 is capable of being handled with one hand 204 by the user. For instance, one finger 214 (e.g., the thumb) can move the safety latch 212 from a locked position to an unlocked position so that the plunger 210 can be depressed. A second finger 218 (e.g., the middle finger) can hold or wrap around a grip member 208 of the body 216 while a third finger 220 (e.g., the index finger) can hold the dispenser 202 in an upright position. The second finger 218 and third finger 220 provide control over the use of the dispenser 202 to avoid liquid contacting the user's body or clothing. Once the safety latch 212 has been moved to the unlocked position, the first finger 214 can depress the plunger 210 for dispensing liquid contained within the body 216 onto the animal 200. After dispensing (i.e., the plunger has moved to a fully dispensed position), the latch 212 can reengage the plunger 210 and lock the plunger 210 in the fully dispensed position. The structural features of the dispenser and their functionality will be better understood with reference to the discussion below.

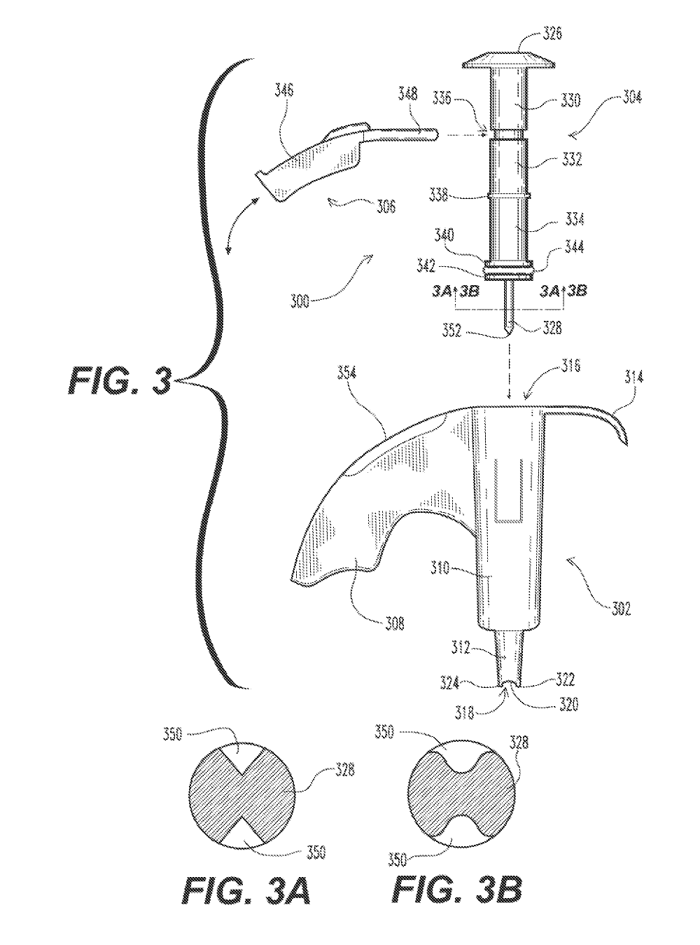

With reference to FIG. 3, one embodiment of a liquid dispenser is provided. The dispenser 300 can include a body 302, a plunger 304, and a latch 306. The body 302 includes a grip member or handle 308 which can be held by one hand of the user. The grip member or handle 308 extends from a substantially cylindrically shaped chamber 310. The chamber 310 can be hollow and include a first opening 316 at one end thereof and a second opening 318 at a second end thereof. In one embodiment, the diameter of the first opening 316 is at least twice the diameter of the second opening 318. In a different embodiment, however, the diameter of the first opening 316 is substantially the same as the diameter of the second opening 318. Alternatively, the ratio of the diameters of the first opening 316 to the second opening 318 can be 3:2, 4:3, 3:1, 5:2, or any other desirable ratio.

At the second end thereof, the chamber 310 forms a tapered tip 312. In other embodiments, the tip 312 can be shaped differently. The second opening 318 is defined at the tip 312. During use, liquid flows from the cylindrical portion 310 of the chamber to the tip 312 and is dispensed through the second opening 318. At the second opening 318, the tip 312 can include lips 322 and 324 (as shown in FIG. 3) that define a gap 320 therebetween. The gap 320 can be important, for example, if the user presses the tip 312 firmly against a surface such as an animal's skin. Liquid can freely exit from the dispenser 300 through the gap 320 formed between the lips 322 and 324 without the tip 312 becoming plugged against the animal.

The body 302 can also include a tab 314 that extends from the chamber 310 opposite the grip member 308. The tab 314 can have a curved shape such that, during use, a first finger of the user's hand can wrap around the grip member 308 while a second finger, typically an index finger, wraps around the tab 314. By holding the dispenser 302 at both the grip member 308 and tab 314, the user is better able to operate the dispenser 302 with a single hand which thereby frees the user's second hand for holding the animal.

The body 302 can be made from plastic or any other material known to the skilled artisan. In one embodiment, the body 302 can be clear or translucent. In this embodiment, liquid contained within the chamber 310 is visible from outside the chamber. Alternatively, the body 302 can be opaque or colored. The body 302 can be formed through an injection molding process such that the grip member 308, chamber 310, tip 312, and tab 314 are integrally formed. In another embodiment, however, it is possible for the grip member 308 and/or tab 314 to be separate parts coupled to the chamber 310.

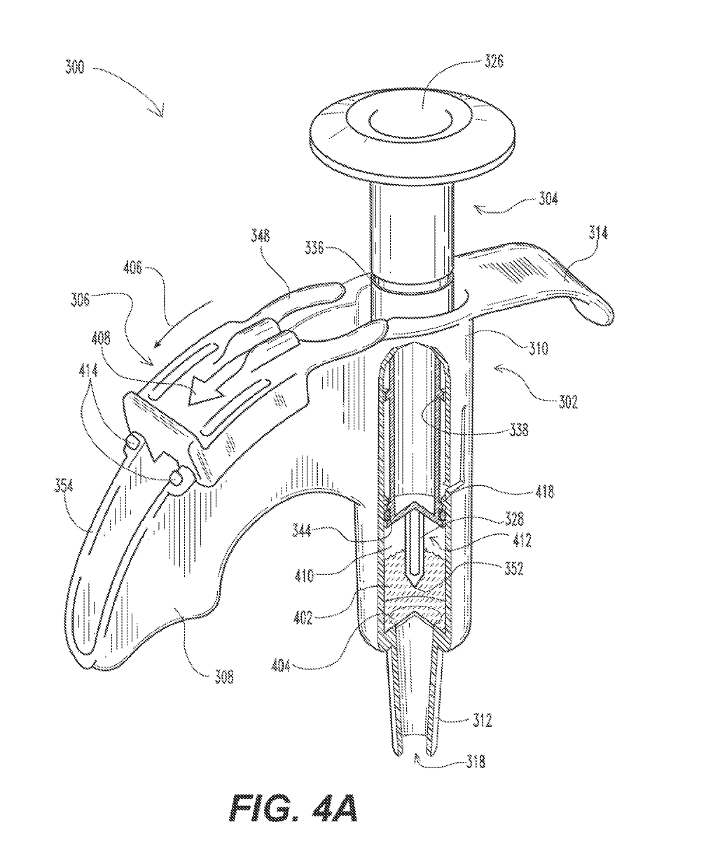

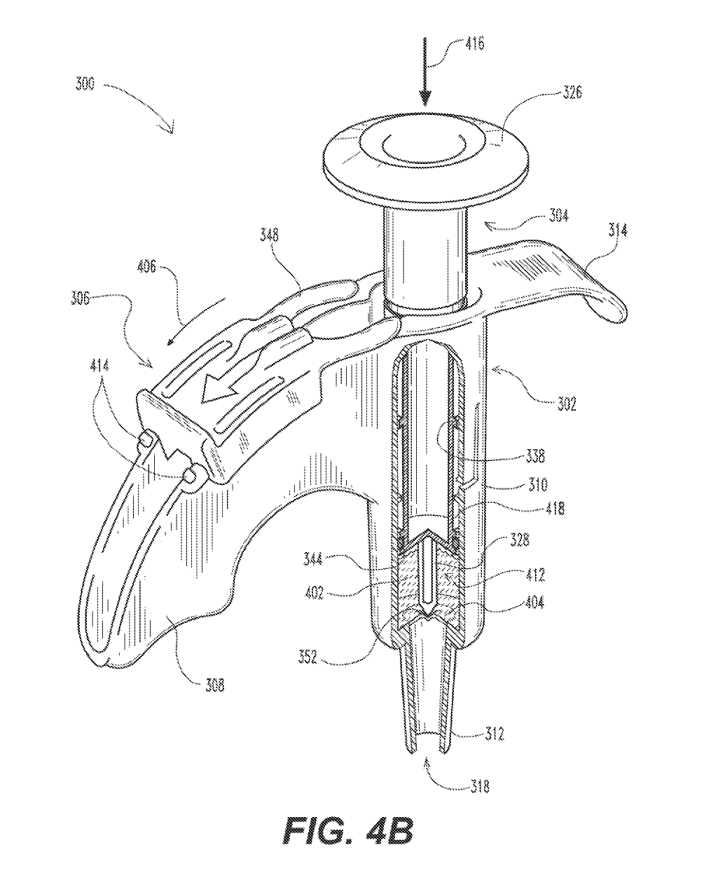

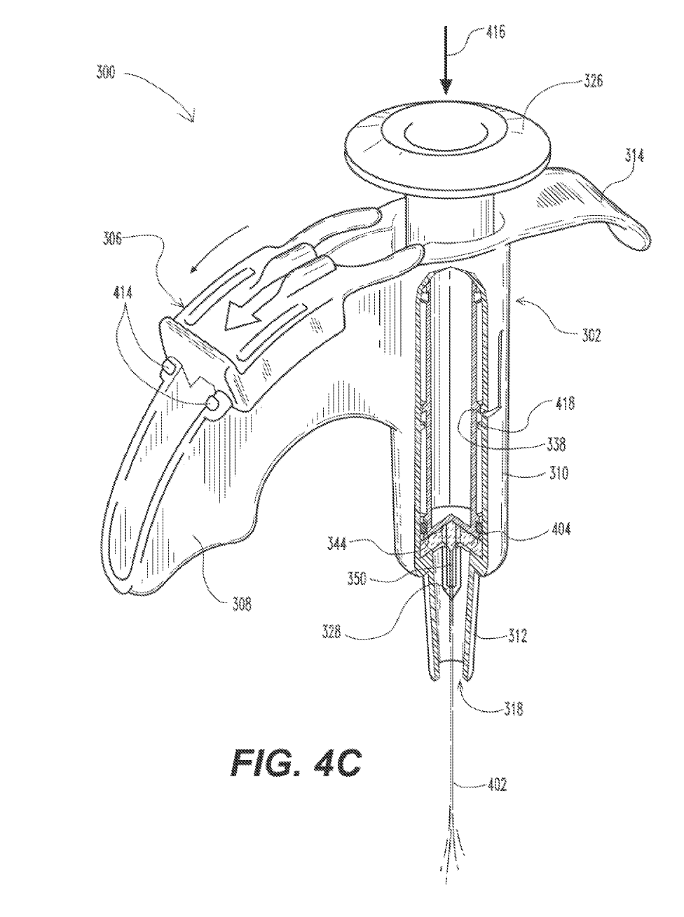

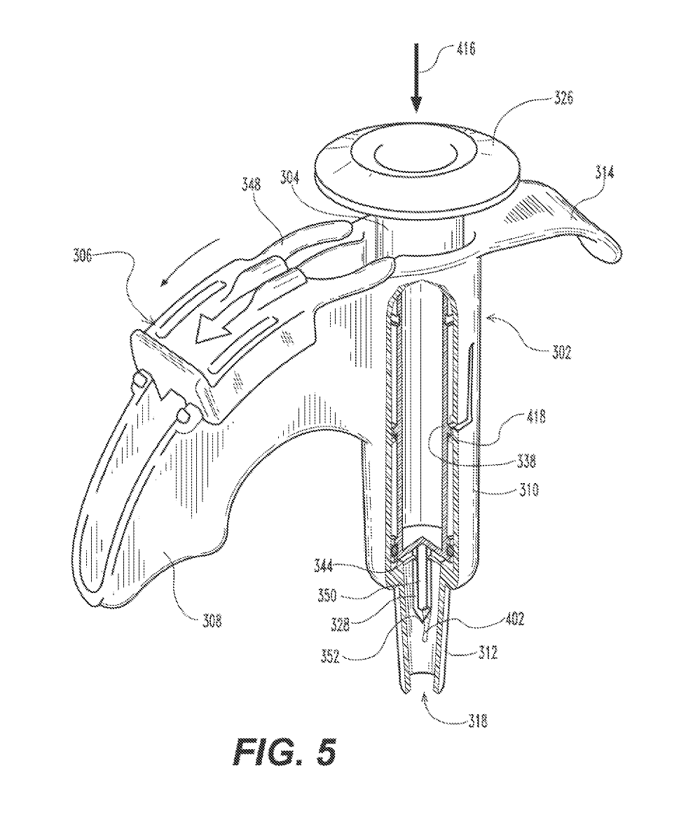

The plunger 304 of the dispenser 300 can be substantially cylindrical along its length and made of plastic. The plunger 304 can also be made of other materials known to the skilled artisan and is not limited to plastic. At one end of the plunger 304 is a button 326 and at a second end is a needle 328. The button 326 can have any cross-sectional shape including circular or oval. The needle 328 is elongate and terminates at a sharp or pointed tip 352. During use, the tip 352 of the needle 328 can pierce a membrane or septum (see FIGS. 4-5) in the chamber 310 of the body 302. With reference to FIGS. 3A and 3B, one or more channels 350 can be defined within or about the needle 328. The one or more channels 350 can extend substantially along the length of the needle 328 such that, during use, liquid can flow along the one or more channels 350 and escape through the chamber 310 without being blocked by the membrane or septum. In FIG. 3A, the one or more channels 350 has a V-shaped cross-section, whereas in FIG. 3B the one or more channels 350 has a curved cross-section. The one or more channels 350, however, can have any cross-sectional shape and is not limited to the V-shaped or curve-shaped cross-sections of FIGS. 3A and 3B, respectively.

Between the button 326 and needle 328, the plunger 304 can have a first cylindrical portion 330, a second cylindrical portion 332, and a third cylindrical portion 334. The diameters of the first cylindrical portion 330, second cylindrical portion 332, and third cylindrical portion 334 can be substantially the same or different. A groove 336 is defined between the first cylindrical portion 330 and the second cylindrical portion 332. The groove 336, as will be explained in detail below, can engage with the latch 306. A rib 338 can be formed between the second cylindrical portion 332 and third cylindrical portion 334. The rib 338 has a diameter that is larger than the diameter of the second cylindrical portion 332 and the third cylindrical portion 334. As will be explained below, when the plunger 304 is inserted into the chamber 310 of the body 302, the rib 338 can engage an annular rib (not shown). When the rib 338 engages the annular rib, the plunger 304 has reached the fully depressed position (see FIG. 5).

Near the tip end 352 of the needle 328, an inner annular ring 340 and an outer annular ring 342 are disposed. The inner annular ring 340 is spaced from the outer annular ring 342 such that a groove is defined therebetween. A seal member 344, such as an o-ring, can be placed in the groove between the inner annular ring 340 and outer annular ring 342. During use, the seal member 344 can prevent liquid from leaking back into the chamber 310.

As described above, the dispenser 300 can further include a latch 306. In FIG. 3, for example, the embodiment of the latch 306 includes a latch body 346 and one or more arms 348 extending therefrom. The one or more arms 348 can be elastic for engaging the groove 336 formed in the plunger 304. The latch 306 can function as a child-resistant lock, and therefore the dispenser 300 provides enhanced safety to its design. The latch 306 can be made from plastic or any other material known to the skilled artisan.

To assemble the dispenser 300, the tip end 352 of the plunger 304 can be inserted into the first opening 316 of the body 302. As the plunger 304 is inserted, the rib 338, which has an outer diameter less than the inner diameter of the cylindrical body 310, slides freely into the chamber 310. The plunger 304, however, is not completely inserted into the body 302. Instead, the plunger 304 is inserted to a particular depth before the latch 306 is moved into engagement with the plunger 304. The latch 306 can slide along a curved surface 354 of the grip member 308 before engaging the plunger 304. To engage or lock the plunger 304, the fork-like arms 348 of the latch 306 elastically engage the groove 336 of the plunger 304. The latch 306 can be pulled away from the plunger 304 to disengage the arms 348 from the groove 336. In alternative embodiments, the latch 306 can include different structure for engaging the plunger 304.

Turning to FIG. 4A, the dispenser 300 is shown with a portion of the body 302 and plunger 304 removed. The plunger 304 is shown in an undepressed or ready position. In this position, a reservoir 412 is formed between the seal member 344 and membrane 404 in the body 302. The reservoir 412 can include air or other gas 410 and a liquid 402 to be dispensed. In the undepressed or ready position, the reservoir 412 has a maximum volume. The tip 352 of the needle 328 extends from the plunger 304 into the reservoir 412 such that the tip 352 is oriented towards the membrane 404. The inner ring 340 of the plunger 304 can contact an annular rib 418 that protrudes radially inward from the chamber 310 of the body 302.

To dispense liquid 402 from the dispenser 300, the latch 306 is moved in the direction of arrow 406 (FIG. 4B) such that the fork-like arms 348 disengage from the groove 336 of the plunger 304. The curved surface 354 of the grip member 308 can function as a track or channel along which the latch 306 can slide. An arrow 408 (FIG. 4A) can be provided on a surface of the latch 306 to instruct a user which way the latch 306 must be moved for disengaging from the plunger 304. To completely disengage the latch 306 from the plunger 304, the latch 306 is moved in the direction of arrow 406 until the latch 306 contacts one or more stoppers 414 that protrude from the curved surface 354 of the grip member 308. In one embodiment, the latch 306 can be removed from the plunger as a separate component. In another embodiment, however, the latch 306 can be slidably coupled to the curved surface 354 of the grip member 308.

Once the latch 306 has been disengaged from the plunger 304, the plunger 304 is free to be depressed. In FIG. 4B, the plunger 304 can be depressed in the direction of arrow 416. A force can be applied to button 326 causing the plunger 304 to move in the direction of arrow 416. The tip 352 of the needle 328 likewise moves in the direction of arrow 416 until it contacts the membrane 404 of the body 302. The membrane 404 can be made from an elastic or deformable material that provides a tactile response to the user once the tip 352 contacts the membrane 404. As shown in FIG. 4B, as the tip 352 contacts the membrane 404, the membrane 404 initially resists the movement of the needle 328. The user therefore must apply additional pressure to the button along the direction of arrow 416 before the tip 352 will pierce the membrane 404.

As the plunger 304 is depressed, the volume of the reservoir 412 decreases. As a result, the air or other gas 410 within the reservoir 412 is compressed between the seal member 344 and the membrane 404. While the air or other gas 410 compresses within the reservoir 412, it does not compress severely enough to rupture or tear the membrane 404. In addition, the compressed air or gas does not resist movement of the plunger 304 along the direction of arrow 416 to the extent that the user is unable to feel when the tip 352 contacts the membrane 404. In other words, the user receives tactile feedback from the membrane 404 when the tip 352 engages the membrane 404, and the user feels significantly less resistance or counter force that opposes the depressing movement of the plunger 304 due to the compressed air or gas. The tactile feedback acts as pneumatic cushioning to the user. Thus, the user can easily distinguish the resistance from the compressed air or gas from the resistance encountered when the tip 352 contacts the membrane 404.

With reference to FIG. 4C, the plunger 304 is depressed further along the direction 416 of arrow such that the needle 328 pierces the membrane 404. As the needle 328 pierces the membrane 404, liquid 402 can be dispensed from the dispenser 300. The liquid 402 can flow along the one or more channels 350 in the needle 328 before exiting through the second opening 318. As noted above, the air or gas 410 within the reservoir 412 continues to compress as the plunger 304 moves along the direction of arrow 416 such that once the tip 352 pierces the membrane 404, liquid 402 is dispensed through the second opening 318. The liquid 402 can exit the dispenser 300 in a jet-like manner which allows the liquid 402 to penetrate or bypass animal fur or hair, for example, and reach the skin of the animal. This is advantageous over conventional dispensers because the user does not have to rub or smear the liquid into the animal's skin for the animal to receive treatment. As a result, the dispenser can provide a more hygienic and effective way for topically applying flea or tick control medication to a domestic animal.

In FIG. 5, the plunger 304 is shown having been fully depressed (i.e., the dispensed position) and most of the liquid 402 has been dispensed through the second opening 318. In this position, the rib 338 of the plunger 304 engages the annular rib 418 of the chamber 310, thereby preventing the plunger 304 from moving any further along the direction of arrow 416. In this embodiment, the dispenser 300 can be discarded or recycled. In alternative embodiments, as will be described in more detail below, a replaceable cartridge can be used such that the dispenser 300 is reusable.

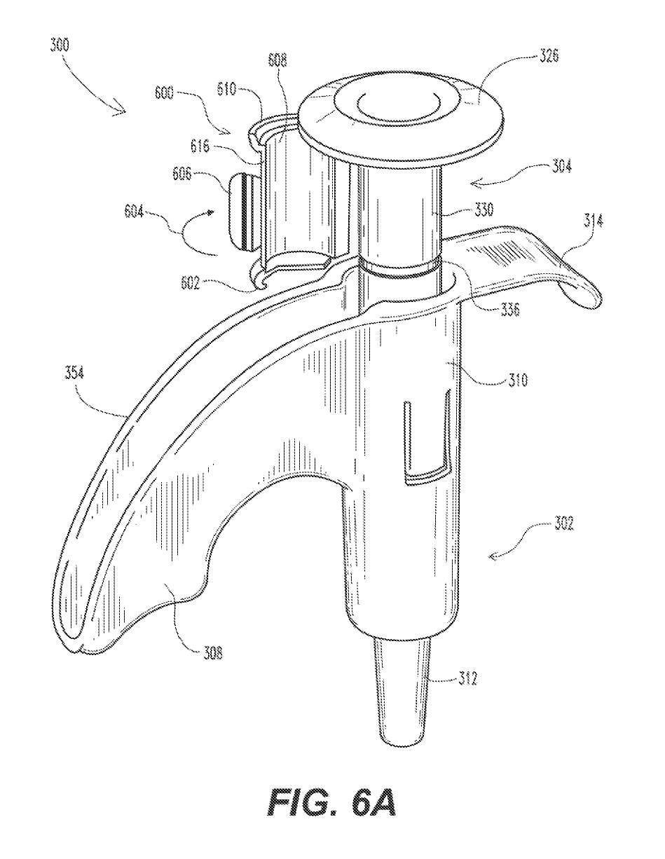

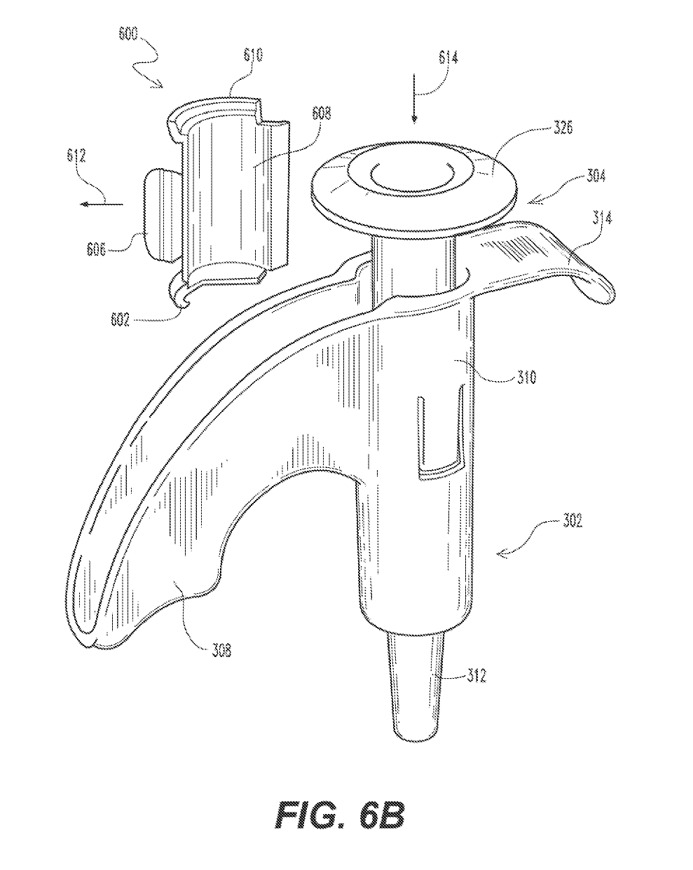

With reference to FIGS. 6A-B, the dispenser 300 includes a body 302, plunger 304, and latch 600. The body 302 and plunger 304 include features similar to those described above with reference to FIGS. 3-5. The latch 600, however, is different in how it engages the plunger 304. Again, the latch 600 can be a child-resistant lock that enhances the safety of the dispenser 300. Rather than sliding along the curved surface 354 of the grip member 308, the latch 600 can be rotated in the direction of arrow 604 for releasing the plunger 304 for use. Until the latch 600 is removed, the plunger 304 cannot be depressed.

The latch 600 can include a hook 602 that engages the groove 336 defined in the plunger 304. The groove 336, for example, can include a lip or raised surface (not shown) which the hook 602 can engage. Alternatively, the hook 602 engages the groove 336 as a press-fit coupling. One skilled in the art can appreciate other ways in which the hook 602 engages the groove 336.

The latch 600 can further include a handle 606 which can be used for pivoting or removing the latch 600 from the plunger 304. Although in the embodiment of FIGS. 6A and 6B the latch 600 is completely removed or disengaged from the plunger, in other embodiments the latch 600 may be hingedly coupled to the plunger 304 whereby the latch 600 is moved to a position which does not interfere with movement of the plunger 304. The handle 606 is coupled or formed as part of the latch body 616. The latch body 616 includes a lip 610 and an inner surface 608 which contacts the outer surface of the plunger 304. For instance, the radius of the latch body 616 is such that the inner surface 608 fits around the first cylindrical portion 330 of the plunger 304. The latch 600 can be made of plastic which is elastic and durable.

To remove the latch 600 from the plunger 304, a user first pulls the handle 606 along the direction of arrow 604. The latch 600 can pivot or be removed, and once removed, the latch 600 can be pulled away from the plunger in the direction of arrow 612. This releases the plunger to be depressed in the direction of arrow 614 for dispensing liquid contained within the body 302.

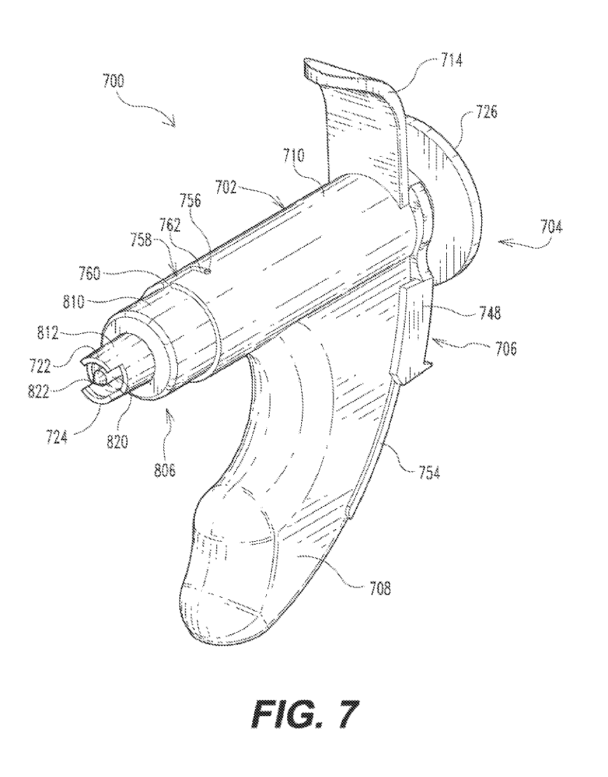

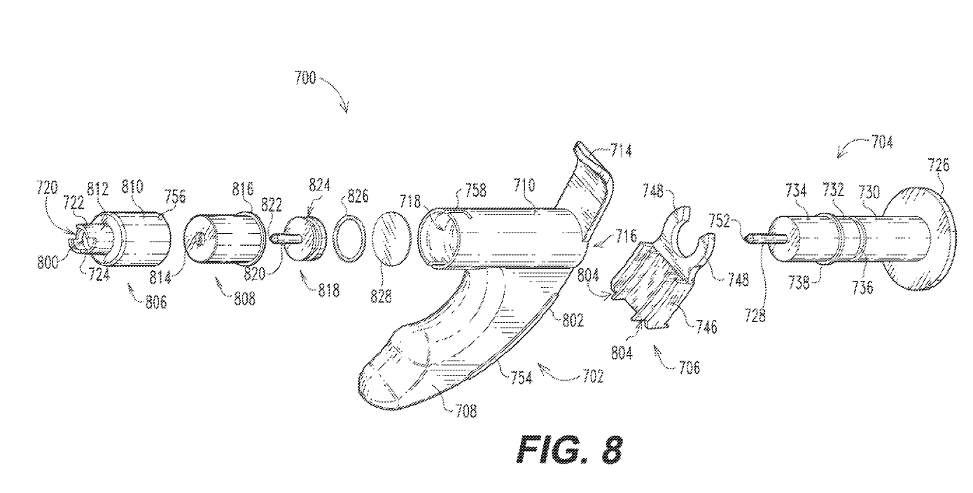

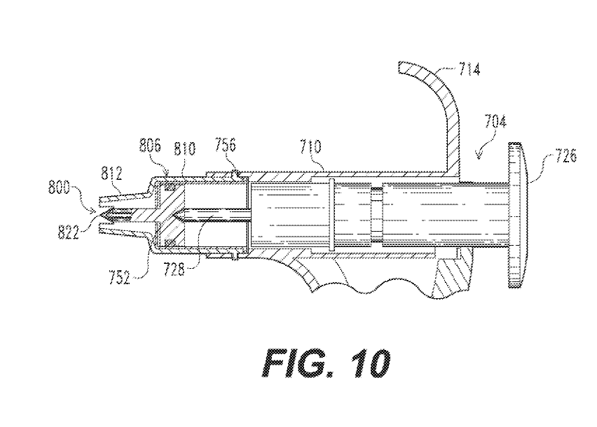

A different embodiment of a liquid dispenser is provided in FIGS. 7-10. The liquid dispenser 700 is operable with a replaceable cartridge 808 (FIG. 8) and therefore can be reused. The liquid dispenser 700 includes a hollow body 702, a plunger 704, and a latch 706. The body 702 can include a chamber portion 710 into which the plunger 704 is inserted. The body 702 also can include a slot or channel 758 defined therein such that a cap 806 for enclosing the cartridge 808 can be coupled thereto. The channel 758 can include a longitudinal portion 760 and a transverse portion 762. In this embodiment, the cap 806 couples to the body 702 via a bayonet-style or “quick-disconnect” coupling. The cap 806 includes a pin 756 that is first inserted into the longitudinal portion 760 of the channel 758. The cap 806 or body 702 is then rotated such that the pin 756 then travels through the transverse portion 762 of the channel 758. In this position, the cap 806 is securely coupled to the body 702. The cap 806 can be coupled to the body 702 in alternative ways including press-fit, screw-fit, snap-tight engagement and in other ways known to the skilled artisan.

The body 702 can include a grip member 708 and handle 714 such that a user can hold the dispenser 700 with a single hand. Meanwhile, the cap 806 can include a thick cylindrical portion 810 and a thin cylindrical portion 812. A dispensing opening 800 (FIG. 8) can be defined in the thin cylindrical portion 812 such that liquid exits the dispenser 700 through the dispensing opening 800. The pin 756 for coupling the cap 806 to the body 702 protrudes from a surface of the thick cylindrical portion 810. Although only one pin 756 is shown in FIGS. 7 and 8, there can be more than one pin 756. In addition, near the dispensing opening 800 of the cap 806, the thin cylindrical portion 812 can include a first extending lip 722 and a second extending lip 724. In FIG. 8, a plurality of gaps 720 is defined between the first extending lip 722 and second extending lip 724 such that liquid that exits through the dispensing opening 800 can also radially pass through the plurality of gaps 720. Thus, if the thin cylindrical portion 812 of the cap 806 is pressed firmly against a surface, during a dispensing operation, liquid can be dispensed radially through the plurality of gaps 720 rather than plugging against the surface.

The plunger 704 can include a button 726 at one end thereof which is pushed to force liquid out of the dispenser 700. In addition, the plunger 704 can include a needle 728 at the opposite end thereof. Between the button 726 and tip 752 of the needle 728, the plunger 704 includes a first cylindrical portion 730, second cylindrical portion 732, and third cylindrical portion 734. A groove 736 that receives the latch 706 is defined between the first cylindrical portion 730 and second cylindrical portion 732 and a rib 738 protrudes from the plunger 704 between the second cylindrical portion 732 and third cylindrical portion 734.

With reference to FIG. 8, the latch 706 can include a latch body 746 and fork-like arms 748 for engaging the groove 736 of the plunger 704. The underside of the latch body 746 defines a pair of channels 804 that can slidably engage a pair of tracks 802 along the curved surface 754 of the grip member 708. To disengage the latch 706 from the plunger 704 in this embodiment, the latch 706 can be moved along the tracks 802 of the grip member 708 away from the plunger 704. The arms 748 can be elastic for engaging the plunger 706 such that the arms 748 can be bent outwardly without breaking or cracking as the latch 706 is disengaged from the plunger 704.

To assemble the dispenser 700, the tip end 752 of the plunger 704 can be inserted to a predefined depth through a first opening 716 defined at one end of the body 702. The predefined depth is established such that the groove 736 of the plunger 704 remains outside of the chamber portion 710 of the body 702 so that the latch arms 748 can engage the groove 736. Once the plunger 704 has been inserted into the chamber portion 710 to the predefined depth, the latch 706 can be coupled to the curved surface 754 of the grip member 708. To do so, the pair of channels 804 of the latch 706 is aligned with the pair of tracks 802 along the curved surface 754. The latch 706 can be slid along the curved surface 754 until the latch arms 748 engage the groove 736 of the plunger 704. Alternatively, the latch 706 may not be required to couple to the curved surface 754 of the grip member 708. Instead, the latch arms 748 can simply be snapped into engagement with the groove 736 of the plunger 704.

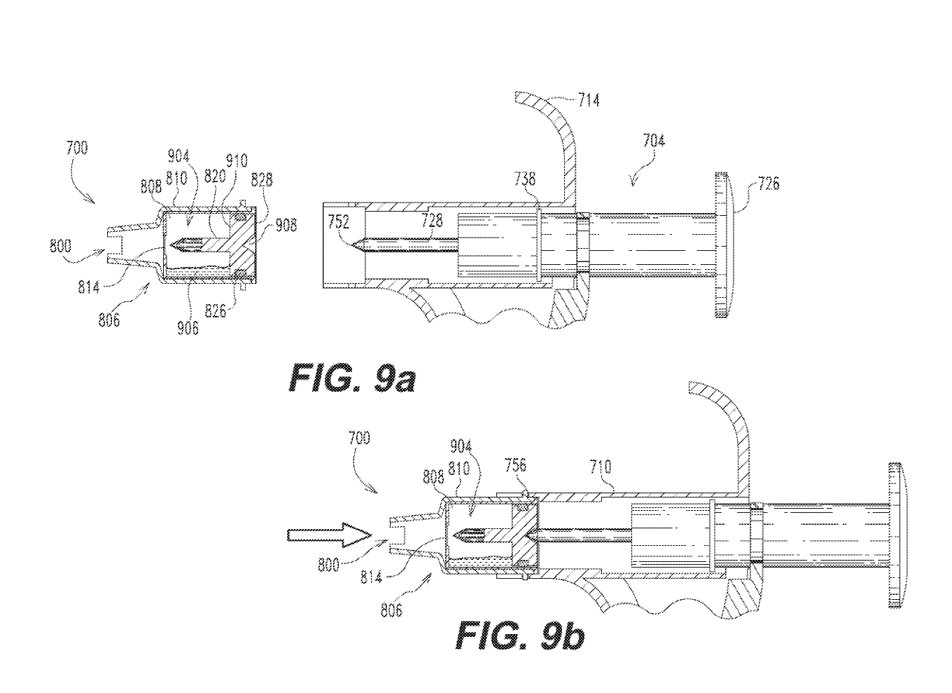

The cap 806 defines a hollow body that has a replaceable cartridge 808 disposed therein which is sealed on the top end by a foil 828. Foil 828 is pierced by needle 752 as the cap is installed on the main body of the dispenser, as can be appreciated by comparing FIGS. 9a and 9b. This “pre-opening” feature reduces the force required during dispensing. That is, because foil 828 has already been broken as the cap is installed, the dispensing movement is easier to execute, i.e., requires less force. The cartridge 808 can be any shape, but in the illustrated embodiment of FIGS. 7-10 the cartridge 808 is cylindrical. Likewise, the cartridge 808 can be made of plastic or any other material known to the skilled artisan. However, it should also be understood that in many embodiments it is desirable to have the cartridge or at least the interior portion thereof that contacts the liquid to be made from a metal foil. One reason for this is that many organic liquids that can be housed in the cartridge in accordance with these teachings may solubilize plastic or volatize through the plastic. Further, due to many plastics allowing penetration of UV light, plastic may also allow photo oxidation. Further, some plastics may allow moisture or oxygen to penetrate them and cause problems that a metal foil can avoid. Aluminum is one particularly suitable metal because it is lightweight and easily piercable, although one of skill in the art would recognize other alternatives. At the end of the cartridge opposite foil 828 is a membrane 814. Like membrane 828, membrane 814 is piercable, and this can promote safe and hygienic handling of the cartridge 808. At the same end of the cartridge 808 as the foil 828, an annular lip or ring 816 protrudes therefrom. The annular lip or ring 816 has an outer diameter that is less than the inner diameter of the cap 806 such that the cartridge 808 can be inserted into the cap 806.

With reference to FIGS. 8-10, the cartridge 808 defines an internal reservoir 904 therein. Liquid 906 and air or other gas are contained within the reservoir 904. The reservoir 904 is defined at one end of the cartridge 808 by the membrane 814 and at the opposite end by a surface 910 of a piston or second plunger 818 (FIG. 8). The second plunger or piston 818 includes a needle 820 having a sharp or pointed tip 822 that protrudes from one end of the second plunger 818 into the reservoir 904. In this embodiment, the needle 820 is aligned with the membrane 814. At the end opposite the needle 820, the second plunger 818 includes a pointed recess 908 (FIG. 9) defined therein for receiving the pointed tip 752 of the plunger 704 during installation of the cap onto the remainder of the device, as discussed above. The second plunger 818 further includes a plurality of grooves 824 (FIG. 8) defined within the circumference or perimeter (depending on the shape of the second plunger) thereof. A plurality of seal members or o-rings 826 can be placed in the plurality of grooves 824 such that the liquid 906 and air or gas cannot leak past the second plunger 818. As such, the liquid 906 and air or other gas are sealingly contained within the cartridge 808.

To dispense liquid 906 from the dispenser 700, the latch 706 first is removed or disengaged from the plunger 704. Once the latch 706 disengages from the plunger 704, the plunger 704 is free to be depressed toward the cap 806. As pressure is applied to the button 726, the plunger 704 likewise moves further into the chamber portion 710 of the body 702 and the needle tip 752 engages the recess 908 defined in the second plunger 818. The shape of the recess 908 is shown as corresponding to the shape of the tip 752, but this is not required. Advantageously, the length of the needle 728 is such that the needle 728 does not buckle when the tip 752 engages the recess 908. The second plunger 818 is movably disposed in the cartridge 808. Therefore, as the tip 752 engages the recess 908, movement of the plunger 704 results in concomitant movement of the second plunger 818 in the same direction. Again, the reservoir 904 is substantially or completely airtight and thus as the second plunger 818 is moved toward the membrane 814, the volume of the reservoir 904 decreases. A decrease in the volume of the reservoir 904 causes the air or other gas to compress.

The plunger 704, which can also be referred to as the first plunger, moves in conjunction with the second plunger 818 at substantially the same speed and acceleration. The first plunger 704 and second plunger 818 can continue to move in the same direction until the tip 822 of the second needle 820 engages the membrane 814. The membrane 814 can offer little to no resistance to the tip 822 such that the tip 822 easily pierces through the membrane 814. Alternatively, however, the membrane 814 can have some amount of elasticity such that as the tip 822 contacts the membrane 814, the user is required to apply additional force to the button 726 before the tip 822 will pierce the membrane 814. As such, the membrane 814 can provide tactile feedback to the user.

As the tip 822 of the second plunger 820 pierces through the membrane 814, liquid 906 and compressed air or gas are forced out of the cartridge 808. The liquid 906 is dispensed through the dispensing opening 800 and/or plurality of gaps 720 defined in the cap 806. One or more channels 902 can be defined in the second needle 820 and extend along a portion of the length of the needle 820. Liquid 906 can exit the reservoir 904 by flowing along the one or more channels 902 and therefore the liquid 906 is not blocked by the membrane 814.

After use, the cap 806 can be twisted such that the pin 756 travels through the transverse portion 762 of channel 758. The cap 806 can then be pulled away from the body 702 as the pin 756 travels through the longitudinal portion 760 of channel 758 until the cap 806 is separated from the body 702. Once the cap 806 is removed from the body 702, the used cartridge 808 can be removed from the cap 806 and replaced. In this embodiment, everything except the cartridge is reusable, thereby reducing waste and expense to the user.

It should also be understood that the cap and cartridge can be formed such that they are not separable from one another. In such embodiments, the entire cap assembly would be a disposable.

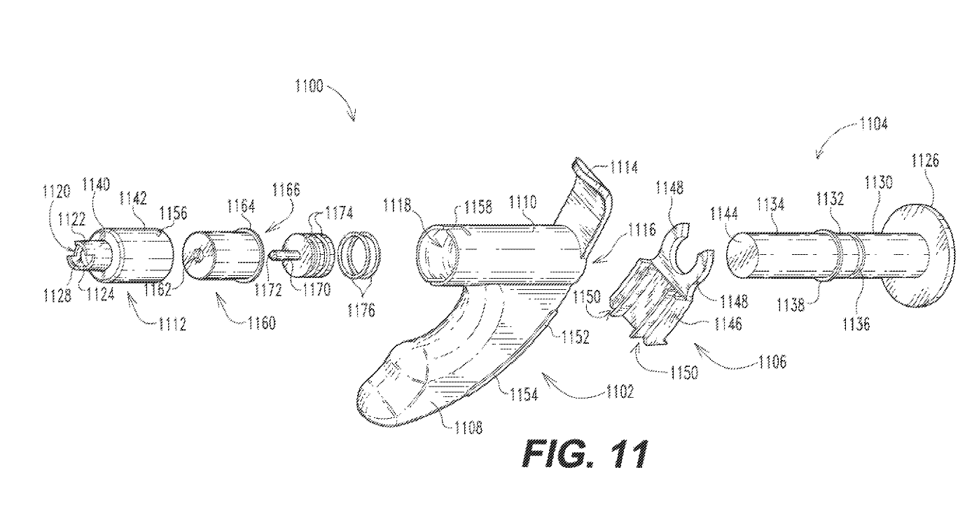

Another alternative embodiment of the liquid dispenser is shown in FIGS. 11-13. The dispenser 1100 comprises structure similar to the dispenser 700 described above. The dispenser 1100 includes a body 1102, a plunger 1104, a latch 1106, and a cap 1112. The body 1102 has a grip member 1108 and handle 1114 to assist with holding the dispenser 1100 with one hand. A curved surface 1154 of the grip member 1108 can include a pair of tracks 1152 along which a pair of channels 1150 defined in the latch 1106 can move. The body 1102 also includes a chamber portion 1110 through which the plunger 1104 moves. The chamber portion 1110 can have a channel or slot 1158 defined therein which comprises a longitudinal portion and a transverse portion. A pin or tab 1156 protruding from the cap 1112 engages the channel or slot 1158 and forms a bayonet-style or “quick-disconnect” fitting that couples the cap 1112 to the body 1102.

Besides the channels 1150, the latch 1106 includes a latch body 1146 and fork-like arms 1148. The fork-like arms 1148 can be elastic for coupling or engaging a groove 1136 defined in the plunger 1104. The plunger 1104 includes a button 1126 which can be pressed or forced in a dispensing direction (i.e., towards the cap 1112). In addition, the plunger 1104 can include a first cylindrical portion 1130, a second cylindrical portion 1132, and a third cylindrical portion 1134. The aforementioned groove 1136 is defined between the first cylindrical portion 1130 and second cylindrical portion 1132 and an annular rib 1138 protrudes radially outward between the second cylindrical portion 1132 and the third cylindrical portion 1134. At the end opposite the button 1126, the plunger 1104 has an end surface 1144 rather than a needle (as in the embodiment of FIG. 8). The end surface 1144 can be planar, recessed, protruding, or any other known design.

The cap 1112 comprises a thin cylindrical portion 1140 and a thick cylindrical portion 1142. The pin or tab 1156 protrudes from the thick cylindrical portion 1142, whereas a dispensing opening 1128 is defined in the thin cylindrical portion 1140. The dispensing opening 1128 is formed by a first extending lip 1122 and a second extending lip 1124. A plurality of gaps 1120 are defined between the first extending lip 1122 and second extending lip 1124 such that liquid can exit the dispenser 1100 through either the dispensing opening 1128 or the plurality of gaps 1120.

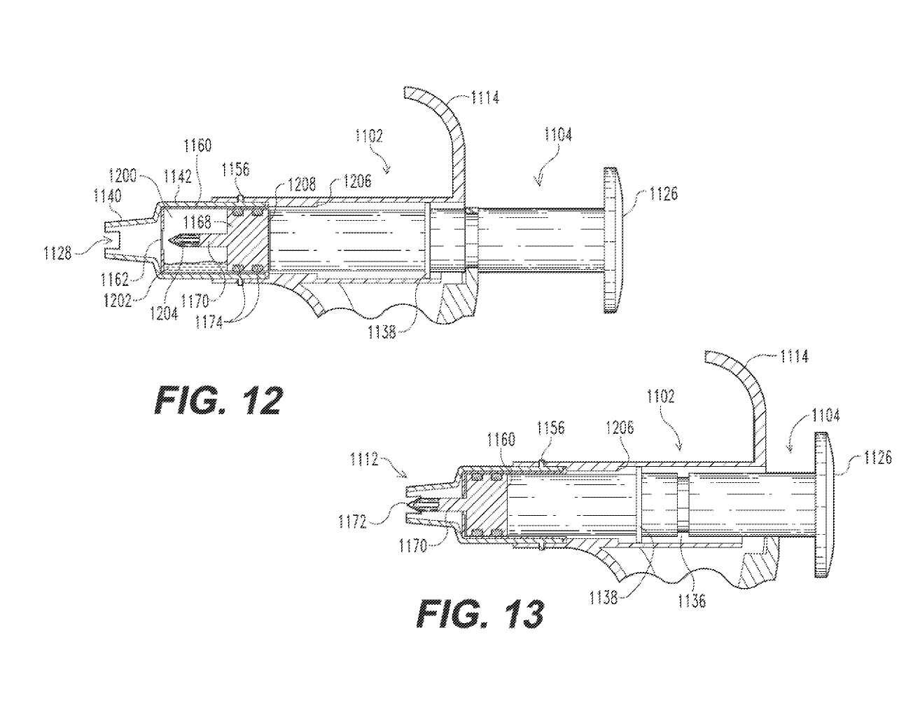

The cap 1112 defines a hollow cavity into which a replaceable cartridge 1160 can be inserted. The cartridge 1160 can be any shape, but in the illustrated embodiment of FIGS. 11-13 the cartridge 1160 is cylindrical and is structurally similar to the cartridge 808 of FIG. 8. Likewise, the cartridge 1160 can be made of plastic or any other material known to the skilled artisan. At one end of the cartridge 1160 is a membrane 1162 and at the opposite end thereof is a planar surface 1208 (FIG. 12) of a second plunger 1168. The membrane 1162 is piercable, but can also provide for safe and hygienic handling of the cartridge 1160. At the end opposite the membrane 1162, the cartridge 1160 includes an annular lip or ring 1164 that protrudes therefrom. The annular lip or ring 1164 has an outer diameter that is less than the inner diameter of the cap 1112 such that the cartridge 1160 can be inserted into the cap 1112.

The second plunger 1168 is movably disposed in the cartridge 1160. During assembly, the second plunger 1168 can be inserted into the cartridge 1160 through an opening 1166 (FIG. 11). The second plunger 1168 can be cylindrical or any other known shape. Along the circumference or perimeter of the second plunger 1168, one or more grooves 1174 are defined therein. One or more seal members 1176, such as o-rings, can be placed within the one or more grooves 1174. Therefore, when the second plunger 1168 is disposed in the cartridge 1160, an airtight reservoir 1200 (FIG. 12) is established between the membrane 1162 and the second plunger 1168. As such, liquid 1202 and air or other gas contained within the reservoir 1200 are unable to leak past the one or more seal members 1176.

The second plunger 1168 can also include a piercing member 1170, i.e., a needle, with a tip 1172 for piercing the membrane 1162. When the second plunger 1168 is assembled with the cartridge 1160, the piercing member 1170 is oriented towards and aligned with the membrane 1162. To further assemble the dispenser 1100, the second plunger 1168 can be press-fit or snapped into the cartridge so long as the second plunger 1168 can move therein. The cap 1112 is coupled to the body 1102 such that the pin or tab 1156 travels through the longitudinal and transverse portions of the channel 1158.

The plunger 1104 can be inserted to a predefined depth through a first opening 1116 of the body 1102. The predefined depth is established such that the groove 1136 of the plunger 1104 remains outside of the chamber portion 1110 of the body 1102 so that the latch arms 1148 can engage the groove 1136. Once the plunger 1104 has been inserted into the chamber portion 1110 to the predefined depth, the latch 1106 can be coupled to the curved surface 1154 of the grip member 1108. To do so, the pair of channels 1150 of the latch 1106 is aligned with the pair of tracks 1152 along the curved surface 1154. The latch 1106 can be slid along the curved surface 1154 until the latch arms 1148 elastically engage the groove 1136 of the plunger 1104. Alternatively, the latch 1106 is not required to couple to the curved surface 1154 of the grip member 1108. Instead, the latch arms 1148 can simply be pressed or snapped into engagement with the groove 1136 of the plunger 1104.

In operation, the latch 1106 is first removed from the plunger 1104, thereby releasing the plunger 1104 for movement. To dispense the liquid 1202, the user applies pressure to the button 1126 of the plunger 1104 (also to be referred to as a first plunger) in a direction towards the cap 1112. As the first plunger 1104 is pressed further into the chamber portion 1110 of the body 1102, the end surface 1144 of the first plunger 1104 contacts the corresponding end surface 1208 of the second plunger 1168. As the first plunger 1104 engages the second plunger 1168, the second plunger 1168 is pushed toward the membrane 1162. The volume of the reservoir 1200 thereby decreases causing the air or other gas to compress. Further movement of the first plunger 1104 and second plunger 1168 causes the piercing member 1170 to contact the membrane 1162. If the membrane 1162 is elastic, the user can feel the tip 1172 of the piercing member 1170 contact the membrane 1162. The tip 1172 can pierce through the membrane 1162 causing liquid 1202 in the reservoir 1200 to dispense therefrom. The liquid 1202 can flow along a plurality of channels 1204 defined along the length of the piercing member 1170. The compressed air or gas can force the liquid 1202 from the dispenser 1100 in a jet-like manner. Again, the liquid 1202 can dispense through the dispensing opening 1128 or plurality of gaps 1120.

After use, the cap 1112 can be removed from the body 1102 and the used cartridge 1160 removed from the cap 1112. A new cartridge 1160 can then be inserted into the cap 1112 for use. The dispenser 1100 therefore is reusable, and the user is only required to purchase new cartridges 1160. Thus, the present embodiment reduces waste and costs to the user.

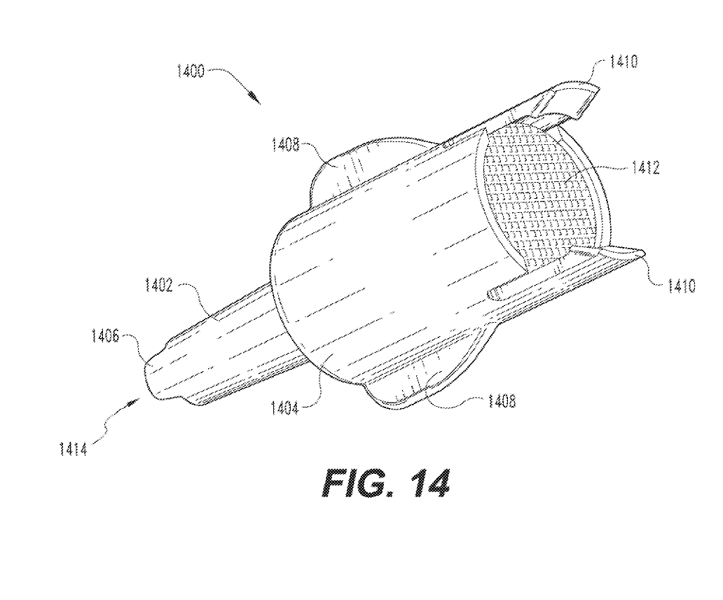

In FIG. 14, a different embodiment of a disposable cap 1400 is shown. The cap 1400 can include a thin portion 1402 and a thick portion 1404. Both the thin portion 1402 and thick portion 1404 can have cylindrical cross-sections, although in other embodiments the cross-section of each portion can vary. The cap 1400 can be made of plastic material such that it is disposed of after use. Other materials can be used for making the cap 1400, but one of the advantages associated with the cap 1400 is that it is disposable.

A dispensing opening 1414 is defined at one end of the cap 1400. The dispensing opening 1414 is formed by a first extending lip 1406 and a second extending lip 1407. A plurality of gaps are defined between the first extending lip 1406 and second extending lip 1407 such that liquid can exit the cap 1400 through either the dispensing opening 1414 or the plurality of gaps.

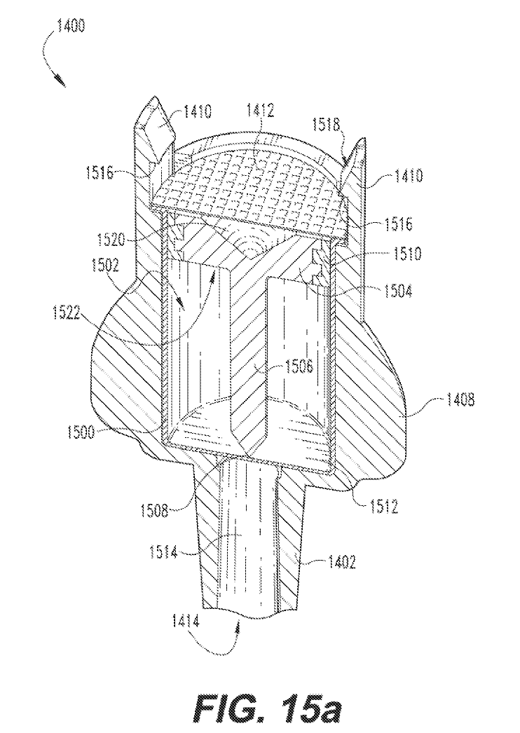

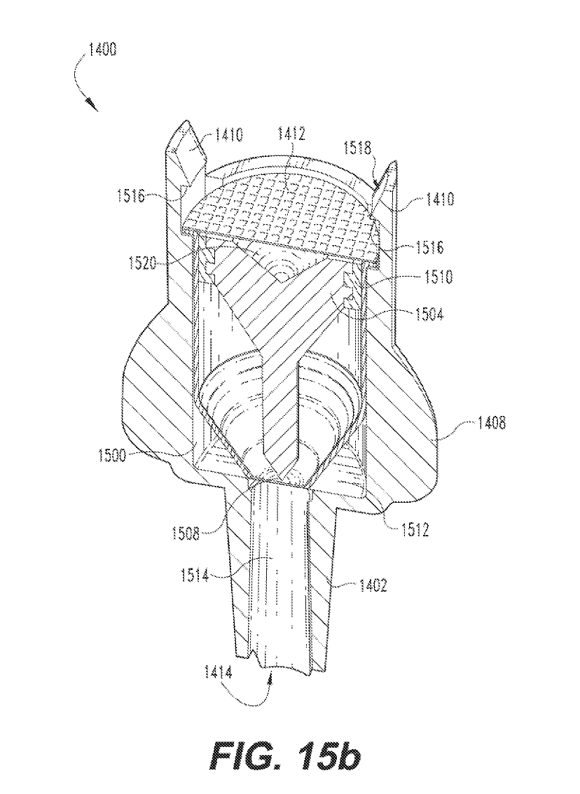

At the opposite end of the cap 1400 is one or more latch arms 1410. Each latch arm 1410 extends from the thick portion 1404 of the cap 1400 and can engage a body of a dispenser. In addition, each latch arm 1410 includes an angled surface 1518 and a latch edge 1516 (see FIG. 15). When the cap 1400 is pressed into engagement with the body of the dispenser, the angled surface 1518 of each latch arm 1410 slides along the surface of the body. The latch arms 1410 are elastic such that as the angled surface 1518 slides along the body, the arms 1410 can bend outward until engaging the body and thus securing the cap to the body. One of skill in the art would appreciate that the latch arms are provided by way of example, and that cap 1400 could define other connectors that removably connect it to the body of the dispenser.

In FIG. 15a, the cap 1400 encloses or surrounds a cartridge 1500 that defines a reservoir 1502 therein. The cartridge 1500 can be made of aluminum, for example, or other materials including various metals or plastics. A liquid such as a pesticide can be contained within the cartridge 1500. In addition to liquid, a gas, a second liquid, or a liquid-gas mixture can be contained within the cartridge 1500. The cartridge 1500 can be cylindrical or various other shapes.

The cap 1400 further includes a foil seal 1412 which is disposed adjacent to the latch arms 1410. The foil seal 1412 provides a liquid-tight seal at one end of the cartridge 1500, whereas a membrane 1512 forms a liquid-tight seal at the opposite end thereof. The foil seal 1412 and membrane 1512 provide for safe and hygienic handling of the cap 1400.

A plunger 1504 is movably disposed in the cartridge 1500 between the foil seal 1412 and membrane 1512. The plunger 1504 is shaped such that it slides along the inner wall of the cartridge 1500. The liquid and/or gas stored within the cartridge 1500 is generally contained between the bottom edge 1522 of the plunger 1504 and the membrane 1512. The circumference or perimeter of the plunger 1504 can include defined grooves in which a seal 1510 is fitted or molded. The seal 1510 provides a liquid-tight seal between the plunger 1504 and inner wall of the cartridge 1500. Alternatively, a plurality of o-rings can be assembled in the grooves of the plunger 1504.

A recess 1520 is defined at one end of the plunger 1504. The recess 1520 is shaped for receiving a tip of a needle or piercing member, typically when the cap is installed, as described above with respect to FIGS. 9a-9b. The recess 1520 can have a conical shape or any other desired shape. At an end opposite the recess 1520, a needle or piercing member 1506 extends from the plunger 1504. The needle or piercing member 1506 includes a tip 1508 for piercing the membrane 1512. Although not shown, the needle or piercing member 1506 can also include channels extending substantially the length of the needle or piercing member such that as the membrane 1512 is pierced, liquid and/or gas can flow along the channels and exit the cap 1400 through the dispensing opening 1414.

FIG. 15b is shows cap 1400 with an alternate embodiment of the plunger 1504. Plunger 1504 shown in FIG. 15b is conically shaped, or tapered. The chamber in which plunger 1504 is moved has a corresponding conical shape as shown in FIG. 15b which promotes a more complete dispensation of the liquid. Further, the corresponding conical shapes tend to guide the tip of the plunger 1504 more precisely to a predefined central location and thus provide a more consistent location at which the foil is pierced. In this connection, it would also be possible to use an absorbent material, e.g., lining the end (bottom) of the cap to retain any residual material that is not dispensed.

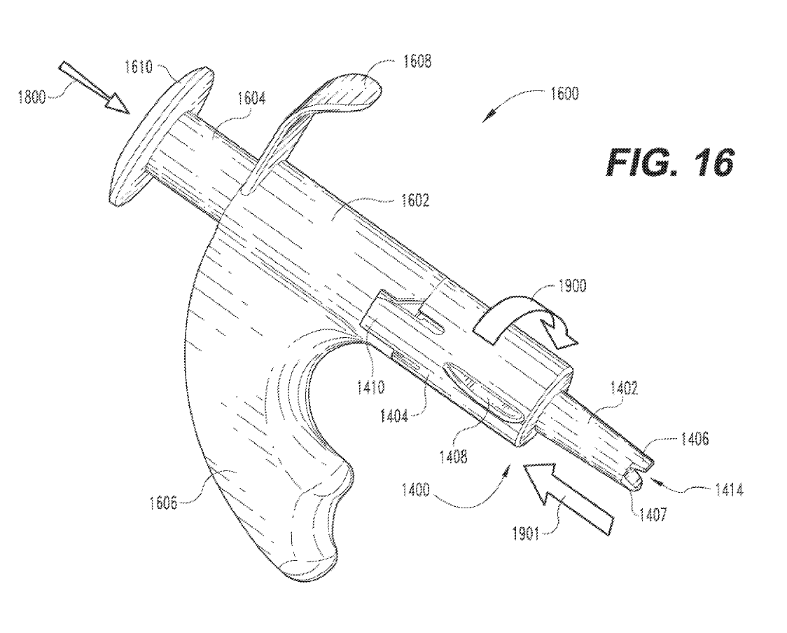

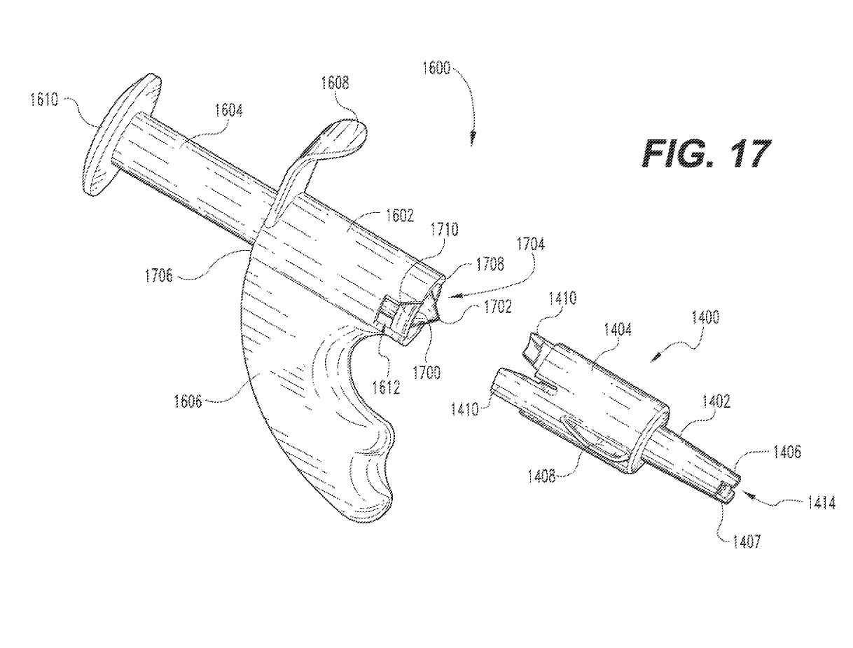

With reference to FIGS. 16 and 17, the cap 1400 can be attached to a hollow body 1602 and main plunger 1604 to form a dispenser 1600. The body 1602 and main plunger 1604 comprise structures similar to the body 1102 and plunger 1104 of FIG. 11. In FIGS. 16 and 17, for example, the main plunger 1604 includes a button 1610 at one end thereof and a needle 1700 at the opposite end. The needle 1700 comprises a tip 1702 for piercing the foil seal 1412 of the cap 1400 during assembly. The tip has a conical shape complementary to recess 1520. The body 1602 can include a grip member 1606 and handle 1608. Although not shown, a finger-actuable safety latch having a structure similar to the latch 1106 of FIG. 11 can be included. If included, the latch can be a child resistant locking latch. In addition, the latch can be removably coupled to the plunger 1604.

The cap 1400 can be coupled to a first end 1704 of the body 1602, whereas the plunger 1604 passes through an opening defined at a second end 1706 of the body. To couple the cap 1400 to the body 1602, the latch arms 1410 are slid into engagement with the body 1602 along the direction of arrow 1901 shown in FIG. 16. In particular, the angled surface 1518 of each latch arm 1410 slides along a surface 1710 of the body 1602 (see FIG. 17). Due to the angle of the angled surface 1518 and elasticity of the latch arm 1410, the latch arm 1410 bends outward as the angled surface 1518 slides along surface 1710. As the cap 1400 couples to the body 1602, each latch arm 1410 snaps into or engages an opening 1612 defined in the body 1602. Once the cap 1400 is coupled to the body 1602, the cap 1400 cannot be pulled away from the body 1602 as the latch edge 1516 abuts the surface 1710 of the body 1602. As described above, as the cap 1400 is coupled to the body 1602, the tip 1702 of the needle 1700 pierces the foil seal 1412 of the cap 1400.

Once the dispenser 1600 is assembled, a user can dispense liquid and/or gas from the cartridge 1500 by applying a force to the button 1610 of the main plunger 1604 in a dispensing direction as shown by arrow 1800 (see FIG. 16). The main plunger 1604 is moved through the body 1602 until the tip 1702 of the needle 1700 engages the recess 1520 of the plunger 1504. The user may need to apply an additional force to move the main plunger 1604 and plunger 1504 concomitantly in the dispensing direction as indicated by arrow 1800. As the plunger 1504 moves in the dispensing direction, air within the reservoir 1502 compresses and the needle or piercing member 1506 contacts the membrane 1512. If the membrane 1512 is elastic, the user can feel the tip 1508 of the needle or piercing member 1506 contact the membrane 1512. The tip 1508 can pierce through the membrane 1512 causing liquid and/or gas in the reservoir 1502 to dispense therefrom. The liquid can flow along a dispensing channel 1514 defined in the thin portion 1402 of the cap 1400.

After the dispensing operation, the cap 1400 can be removed from the body 1602. To assist with the removal of the cap 1400, wings 1408 protrude from the thick portion 1404 of the cap 1400. A user twists the cap 1400 by rotating the wings 1408 along the direction indicated by arrow 1900 to disengage the latch arms 1410 from the openings 1612 defined in the body 1602. It can thus be appreciated that the cap is installed in a linear or longitudinal direction with respect to the dispenser body, whereas it is removed in a twisting movement. Importantly, these features allow the cap to be snapped on in a robust manner, tightly, so that it can withstand the dispensing action. In any event, once the latch arms 1410 are disengaged from the openings 1612, the cap 1400 can be pulled away from the body 1602. The cap 1400 can be disposed of after use. To perform another dispensing operation, a new cap 1400 is coupled to the body 1602 as described above. In one embodiment, for example, a plurality of caps are provided, each of which is removably and interchangeably coupled to the body.

While exemplary embodiments incorporating the principles of the present invention have been disclosed hereinabove, the present invention is not limited to the disclosed embodiments. Instead, this application is intended to cover any variations, uses, or adaptations of the invention using its general principles. Further, this application is intended to cover such departures from the present disclosure as come within known or customary practice in the art to which this invention pertains and which fall within the limits of the appended claims.

The following is a list of preferred embodiments of the invention:
1. A method of dispensing liquid from a dispenser onto an animal, the dispenser being of the type having a body, a chamber containing the liquid to be dispensed, and a moveable plunger, the method comprising:

placing a tip of the dispenser on or near the skin of the animal;

depressing the plunger and thereby compressing gas located in the chamber, wherein the depressing causes a piercing member to pierce a membrane and form an opening in the membrane; and

dispensing at least some of the liquid through an opening of the dispenser onto the skin of the animal.
2. The method of embodiment 1, further comprising unlocking the plunger before the depressing step.
3. The method of embodiment 2, wherein the unlocking step comprises disengaging a latch from the plunger.
4. The method of embodiment 3, wherein the unlocking step comprises sliding the latch along a surface of the body.
5. The method of embodiment 2, further comprising using the same finger or thumb for the depressing step and the unlocking step.
6. The method of embodiment 2, wherein one hand of a user performs the depressing step and the unlocking step while the user's other hand substantially continuously holds the animal.
7. The method of embodiment 1, further comprising locking the plunger in place after it is fully depressed.
8. The method of embodiment 1, further comprising providing tactile feedback to the user during the depressing step, the tactile feedback comprising initial resistance against the depression and a click or snap perceptible to the user when the plunger is fully depressed.
9. The method of embodiment 1, further comprising substantially depleting the liquid from the dispenser.
10. The method of embodiment 1, wherein an entire dose is dispensed in a single stroke of the plunger.
11. The method of embodiment 1, wherein the piercing of the membrane comprises the plunger pushing the piercing member through the membrane.
12. The method of embodiment 11, wherein the piercing member moves in substantially the same direction as the plunger.
13. The method of embodiment 11, wherein as the piercing member pierces the membrane, at least some of the liquid flows through the opening along a channel defined in the piercing member.
14. The method of embodiment 1, further comprising dispensing the liquid from the dispenser at a high velocity.
15. The method of embodiment 1, wherein the depression step provides a tactile sensation to the user.
16. The method of embodiment 1, wherein the plunger is depressed substantially linearly through the body.
17. The method of embodiment 1, further comprising coupling a cap to one end of the body, the cap comprising the dispensing opening through which liquid exits the dispenser, the cap further comprising a cartridge which includes the membrane disposed at one end and a foil at an opposite end.
18. The method of embodiment 17, further comprising inserting the cartridge into the cap.
19. The method of embodiment 17, wherein movement of the plunger causes the piercing member to pierce the membrane in the cartridge and create an opening in the membrane through which liquid can exit.
20. The method of embodiment 19, wherein an end of the plunger pierces the foil in the cartridge.
21. The method of embodiment 17, further comprising contacting the plunger with a piston movably disposed in the cartridge.
22. The method of embodiment 21, further comprising moving the piston and thereby compressing the gas located in the cartridge.
23. The method of embodiment 21, wherein the piercing member extends from the piston and the piercing of the membrane comprises pushing the piercing member through the membrane.
24. The method of embodiment 23, wherein the piercing member is pushed in substantially the same direction as the plunger when the plunger is depressed.
25. The method of embodiment 23, wherein as the piercing member pierces the membrane, at least some of the liquid flows through the opening along a channel defined in the piercing member.
26. The method of embodiment 21, wherein the contacting step comprises moving a tip of the plunger into a recess defined in the piston.
27. The method of embodiment 17, further comprising decoupling the cap from the body after a dispensing operation.
28. The method of embodiment 27, wherein the decoupling step comprises twisting the cap.
29. The method of embodiment 28, wherein the twisting step comprises applying pressure to at least one wing that extends from the cap.
30. The method of embodiment 27, further comprising replacing the cap with a new cap.
31. The method of embodiment 27, further comprising replacing the cartridge with a new cartridge.
32. The method of embodiment 31, wherein the replacing step comprises inserting the new cartridge into the cap such that, after the inserting step, the membrane is disposed adjacent the dispensing opening.
33. The method of embodiment 31, wherein the replacing step comprises removing the cartridge from the cap.
34. The method of embodiment 30, wherein the replacing step comprises coupling the new cap to the body.
35. The method of embodiment 34, wherein the coupling step comprises sliding a pin defined by the new cap through a slot defined in the body.
36. The method of embodiment 17, wherein the dispensing step comprises dispensing at least some of the liquid through a plurality of gaps defined in the cap.
37. The method of embodiment 17, wherein as the cap is coupled to the body, the plunger pierces the foil of the cartridge.
38. The method of embodiment 17, wherein the coupling step comprises engaging a latch arm of the cap with an opening defined in the body.
39. The method of embodiment 38, further comprising aligning the latch arm with the opening and sliding the latch arm along the outer surface of the body until it engages the opening.
40. A method of dispensing a liquid from a dispenser onto an animal, the dispenser being of the type having a body, a chamber containing the liquid to be dispensed, and a moveable plunger, the method comprising:

(a) gripping the dispenser with one hand;

(b) placing the tip of the dispenser on or near the skin of the animal;

(c) unlocking a latch of the dispenser with the one hand and thereby freeing the plunger; and

(d) depressing the plunger with the one hand and thereby dispensing at least some of the liquid through the opening.
41. The method of embodiment 40, wherein step (c) comprises disengaging the latch from the plunger.
42. The method of embodiment 40, further comprising using the same finger or thumb of the one hand during steps (c) and (d).
43. The method of embodiment 40, further comprising the user using a second hand to substantially continuously hold the animal during at least steps (b), (c) and (d).
44. The method of embodiment 43, wherein the one hand substantially continuously holds the dispenser during at least steps (b), (c) and (d).
45. The method of embodiment 40, further comprising locking the plunger in place after it is fully depressed during step (d).
46. The method of embodiment 40, further comprising providing tactile feedback to the user during step (d), the tactile feedback comprising initial resistance against the depression and a click or snap perceptible to the user when the plunger is fully depressed.
47. The method of embodiment 46, wherein the tactile feedback further comprises pneumatic cushioning.
48. The method of embodiment 40, further comprising substantially depleting the liquid from the dispenser.
49. The method of embodiment 40, wherein an entire dose is dispensed in a single stroke of the plunger.
50. The method of embodiment 40, further comprising piercing a membrane of the chamber during step (d) and thereby producing an opening through which the liquid is dispensed.
51. The method of embodiment 50, wherein the piercing of the membrane comprises pushing a piercing member defined by the plunger through the membrane.
52. The method of embodiment 51, wherein the piercing member is moved in substantially the same direction as the plunger.
53. The method of embodiment 51, wherein as the piercing member pierces the membrane, at least some of the liquid flows through the opening along a channel defined in the piercing member.
54. The method of embodiment 40, wherein the liquid comprises a flea or tick treatment.
55. The method of embodiment 40, further comprising dispensing the liquid from the dispenser at a high velocity.
56. The method of embodiment 40, wherein the depression step provides a tactile sensation to the user.
57. The method of embodiment 40, wherein the plunger is depressed linearly through the body.
58. A liquid dispenser, comprising:

a hollow body having a grip member extending therefrom;

a plunger movably disposed in the body, wherein movement of the plunger pierces a membrane and creates an opening in the membrane for liquid to exit the dispenser;

a latch movably coupled to the body and positioned near the plunger, wherein movement of the latch releases the plunger for movement; and

the plunger and latch being positioned relative to the grip member such that when a user's hand grips the dispenser the same finger of the user can actuate the latch and the plunger without releasing the grip member.
59. The dispenser of embodiment 58, wherein the plunger comprises a needle, the plunger being movable between a first position and a second position, wherein the needle pierces and at least partially extends through the membrane as the plunger is moved from the first position to the second position.
60. The dispenser of embodiment 59, wherein the needle comprises a channel extending at least partially along the length of the needle.
61. The dispenser of embodiment 59, wherein the needle and membrane cooperate during the piercing to form at least one passageway through which liquid can escape from the dispenser.
62. The dispenser of embodiment 61, wherein the at least one passageway is located laterally from the needle.
63. The dispenser of embodiment 59, wherein the body defines a first opening into which the plunger extends and a second opening through which liquid is dispensed.
64. The dispenser of embodiment 63, wherein the membrane is disposed intermediate the first opening and the second opening.
65. The dispenser of embodiment 59, wherein, in the second position, a tip of the needle is located in the body.
66. The dispenser of embodiment 59, wherein, in the first position, liquid is disposed intermediate the plunger and the membrane.
67. The dispenser of embodiment 58, further comprising a sealing member movingly disposed intermediate the body and plunger.
68. The dispenser of embodiment 67, wherein the sealing member comprises an o-ring circumferentially disposed about the plunger.
69. The dispenser of embodiment 58, wherein the membrane is integrally formed with the body.
70. The dispenser of embodiment 69, wherein the body comprises an injection molded component.
71. The dispenser of embodiment 58, wherein the latch is slidable between a first position in which the latch engages the plunger and prevents the plunger from being depressed until the dispenser is ready to be used and a second position in which the latch is disengaged from the plunger and the plunger is thereby released for movement.
72. The dispenser of embodiment 71, wherein the latch comprises an arm that engages a groove disposed in the plunger in the first position.
73. The dispenser of embodiment 58, further comprising a lock which engages the plunger when the plunger reaches the dispensed position and holds the plunger in the second position.
74. The dispenser of embodiment 58, wherein the grip member comprises at least one groove for a finger of the user.
75. The dispenser of embodiment 58, wherein the membrane is deformable.
76. The dispenser of embodiment 58, wherein the body defines a reservoir having the membrane at one end thereof, the plunger having a sealing member movably disposed at a second end of the reservoir.
77. The dispenser of embodiment 76, wherein the reservoir comprises liquid and gas.
78. The dispenser of embodiment 77, wherein, as the plunger moves toward the membrane, the gas is compressed.
79. The dispenser of embodiment 58, wherein the hollow body comprises a cap disposed at one end thereof.
80. The dispenser of embodiment 79, wherein the cap is removably coupleable to the body.
81. The dispenser of embodiment 80, wherein the cap is removably coupleable to the body via a bayonet-style fitting.
82. The dispenser of embodiment 79, wherein the cap defines a dispensing opening.
83. The dispenser of embodiment 79, further comprising a cartridge removably disposed in the cap, the membrane being disposed at one end of the cartridge.
84. The dispenser of embodiment 83, further comprising a piston movably disposed in the cartridge, the piston being operable by the plunger.
85. The dispenser of embodiment 84, wherein movement of the piston pierces the membrane and creates an opening in the membrane for liquid to exit the dispenser.
86. The dispenser of embodiment 84, wherein the piston comprises a piercing member for piercing the membrane.
87. The dispenser of embodiment 86, wherein the piercing member comprises a plurality of channels defined therein.
88. The dispenser of embodiment 87, wherein, as the piercing member pierces the membrane, liquid flows along the plurality of channels and exits the dispenser.
89. The dispenser of embodiment 86, wherein the piercing member comprises a tip oriented towards and aligned with the membrane.
90. The dispenser of embodiment 84, wherein the plunger is substantially aligned with the piston.
91. The liquid dispenser of embodiment 84, wherein, during use, the plunger moves in a dispensing direction and contacts the piston.
92. The liquid dispenser of embodiment 91, wherein, after the plunger contacts the piston, the plunger and piston move substantially together in the dispensing direction.
93. The liquid dispenser of embodiment 91, wherein the plunger includes a needle that contacts the piston.
94. The liquid dispenser of embodiment 93, wherein, during contact, the tip of the needle engages a recess defined in the piston.
95. The dispenser of embodiment 83, wherein the cartridge comprises a foil disposed at an end opposite the membrane.
96. The dispenser of embodiment 83, wherein, before use, the plunger is spaced from the cartridge.
97. A method of manufacturing a dispenser, comprising:

providing a dispenser body having a chamber;

adding a liquid to the chamber;

inserting a plunger into the chamber;

forming a substantially airtight seal between the chamber and the plunger;

holding the plunger at a desired depth within the chamber; and

engaging the plunger with a releasable latch to hold the plunger in place until use.
98. The method of embodiment 97, wherein the forming a substantially airtight seal step comprises placing an o-ring in a groove of the plunger.
99. The method of embodiment 97, wherein the adding a liquid step is completed before the inserting a plunger step.
100. The method of embodiment 97, further comprising forming a grip member integral with the dispenser body.
101. The method of embodiment 97, wherein the engaging the plunger step comprises engaging an arm of the latch in a groove disposed in the plunger.
102. The method of embodiment 97, further comprising providing the plunger with a piercing member at one end thereof.
103. The method of embodiment 102, wherein the inserting a plunger step comprises sliding the piercing member of the plunger into the chamber.
104. The method of embodiment 97, further comprising forming a reservoir in the chamber, the reservoir defined by a membrane at one end thereof and the airtight seal at a second end of the reservoir.
105. The method of embodiment 104, wherein, as the plunger is inserted into the chamber, air in the reservoir is compressed.
106. The method of embodiment 97, further comprising providing the dispenser body with a membrane integrally formed therein.
107. The method of embodiment 106, wherein, as the plunger is inserted into the chamber, a tip of the plunger is spaced from the membrane.
108. A liquid dispenser, comprising:

a hollow body having a grip member;

a cap coupled to one end of the body and defining a dispensing opening;

a cartridge disposed in the cap, the cartridge having a membrane; and

a plunger movably disposed in the body, wherein movement of the plunger pierces the membrane and creates an opening in the membrane for liquid to exit the dispenser.
109. The liquid dispenser of embodiment 108, wherein the cartridge is removably disposed in the cap.
110. The liquid dispenser of embodiment 108, further comprising a latch movably coupled to the body and positioned near the plunger, wherein movement of the latch releases the plunger for movement.
111. The liquid dispenser of embodiment 110, wherein the grip member comprises a plurality of tracks along which the latch can be moved.
112. The liquid dispenser of embodiment 111, wherein the latch comprises a plurality of channels for movably coupling to the plurality of tracks.
113. The liquid dispenser of embodiment 110, wherein the latch comprises a plurality of fork-like arms for engaging the plunger.
114. The liquid dispenser of embodiment 108, wherein the cap couples to the body via a bayonet-style fitting.
115. The liquid dispenser of embodiment 108, wherein the cap comprises a plurality of latch arms for engaging with openings defined in the body.
116. The liquid dispenser of embodiment 108, wherein the cap comprises a substantially cylindrical portion and a tapered portion, the dispensing opening defined at the tapered portion.
117. The liquid dispenser of embodiment 108, wherein the cap comprises a thin portion and a thick portion, the thin portion defining a dispensing channel through which liquid travels during dispensing.
118. The liquid dispenser of embodiment 108, wherein the cartridge comprises a housing with the membrane disposed at one end thereof.
119. The liquid dispenser of embodiment 108, further comprising a piston movably disposed in the cartridge.
120. The liquid dispenser of embodiment 119, wherein movement of the piston pierces the membrane and creates an opening in the membrane for liquid to exit the dispenser.
121. The liquid dispenser of embodiment 119, wherein the piston comprises a piercing member for piercing the membrane.
122. The liquid dispenser of embodiment 121, wherein the piercing member comprises a plurality of channels defined therein.
123. The liquid dispenser of embodiment 122, wherein, as the piercing member pierces the membrane, liquid flows along the plurality of channels and exits the dispenser.
124. The liquid dispenser of embodiment 121, wherein the piercing member comprises a tip pointed toward the membrane.
125. The liquid dispenser of embodiment 119, further comprising a sealing member disposed intermediate the piston and the cartridge.
126. The liquid dispenser of embodiment 125, wherein the sealing member is disposed in a groove defined in the outer surface of the piston.
127. The liquid dispenser of embodiment 125, wherein the sealing member is molded onto the plunger.
128. The liquid dispenser of embodiment 125, wherein the sealing member comprises an o-ring.
129. The liquid dispenser of embodiment 125, further comprising a reservoir defined by the membrane, the sealing member, and the inner surface of the cartridge.
130. The liquid dispenser of embodiment 129, wherein the reservoir comprises liquid and gas.
131. The liquid dispenser of embodiment 130, wherein the liquid comprises a pesticide for treating animals.
132. The liquid dispenser of embodiment 130, wherein, as the piston moves in a direction towards the membrane, the air in the reservoir is compressed.
133. The liquid dispenser of embodiment 119, wherein the plunger is substantially aligned with the piston.
134. The liquid dispenser of embodiment 119, wherein, during use, the plunger moves in a dispensing direction and contacts the piston.
135. The liquid dispenser of embodiment 134, wherein, after the plunger contacts the piston, the plunger and piston move substantially together in the dispensing direction.
136. The liquid dispenser of embodiment 134, wherein the plunger includes a needle that contacts the piston.
137. The liquid dispenser of embodiment 136, wherein, during contact, the tip of the needle engages a recess defined in the piston.
138. The liquid dispenser of embodiment 134, wherein, after the plunger contacts the piston, at least a portion of the plunger becomes movably disposed in the cartridge.
139. The liquid dispenser of embodiment 108, wherein the dispensing opening is defined at one end of the cap and a foil seal is disposed at the opposite end thereof.
140. The liquid dispenser of embodiment 139, wherein as the cap is coupled to the body, the plunger pierces the foil seal.
141. The liquid dispenser of embodiment 108, wherein the cap is disposable.
142. The liquid dispenser of embodiment 108, wherein the cap comprises a plurality of wings that extend radially outward therefrom.
143. A liquid dispensing system, comprising:

a dispenser, comprising:

a hollow body having a grip member;

a cap coupled to one end of the body, the cap defining a dispensing opening at an end opposite the body; and

a plunger movably disposed in the body; and

a plurality of cartridges, each cartridge having a membrane and being removably and interchangeably receivable in the cap.
144. The liquid dispensing system of embodiment 143, wherein the movement of the plunger causes the plunger to pierce the membrane and create an opening in the membrane for liquid to exit the dispenser.
145. The liquid dispensing system of embodiment 143, further comprising a finger-actuable latch movably coupled to the body and positioned near the finger-actuable plunger, wherein movement of the latch releases the plunger for movement.
146. The liquid dispensing system of embodiment 145, wherein the grip member comprises a plurality of tracks along which the latch can move.
147. The liquid dispensing system of embodiment 146, wherein the latch comprises a plurality of channels for movably coupling to the plurality of tracks.
148. The liquid dispensing system of embodiment 145, wherein the latch comprises a plurality of fork-like arms for engaging the plunger.
149. The liquid dispensing system of embodiment 143, wherein the cap couples to the body via a bayonet-style fitting.
150. The liquid dispensing system of embodiment 143, wherein the cap comprises a substantially cylindrical portion and a tapered portion, the dispensing opening defined at one end of the tapered portion.
151. The liquid dispensing system of embodiment 143, wherein the body is substantially transparent.
152. The liquid dispensing system of embodiment 143, wherein the cartridge comprises a housing with the membrane disposed at one end thereof.
153. The liquid dispensing system of embodiment 152, further comprising a piston movably disposed in the cartridge.
154. The liquid dispensing system of embodiment 153, wherein movement of the piston pierces the membrane and creates an opening in the membrane for liquid to exit the dispenser.
155. The liquid dispensing system of embodiment 153, wherein the piston comprises a piercing member for piercing the membrane.
156. The liquid dispensing system of embodiment 155, wherein the piercing member comprises a plurality of channels defined therein.
157. The liquid dispensing system of embodiment 156, wherein, as the piercing member pierces the membrane, liquid flows along the plurality of channels and exits the dispenser.
158. The liquid dispensing system of embodiment 153, further comprising a sealing member disposed intermediate the piston and the cartridge.
159. The liquid dispensing system of embodiment 158, wherein the sealing member is disposed in a groove defined in the outer surface of the piston.
160. The liquid dispensing system of embodiment 158, wherein the sealing member comprises an o-ring.
161. The liquid dispensing system of embodiment 158, further comprising a reservoir defined by the membrane, the sealing member, and the inner surface of the cartridge.
162. The liquid dispensing system of embodiment 161, wherein the reservoir comprises liquid and gas.
163. The liquid dispensing system of embodiment 162, wherein the liquid comprises a pesticide for treating animals.
164. The liquid dispensing system of embodiment 162, wherein, as the piston moves in a direction towards the membrane, the air in the reservoir is compressed.
165. The liquid dispensing system of embodiment 153, wherein the plunger is substantially aligned with the piston.
166. The liquid dispensing system of embodiment 153, wherein, during use, the plunger moves in a dispensing direction and contacts the piston.
167. The liquid dispensing system of embodiment 166, wherein, after the plunger contacts the piston, the plunger and piston move substantially concomitantly in the dispensing direction.
167. The liquid dispensing system of embodiment 166, wherein the plunger includes a needle that contacts the piston.
168. The liquid dispensing system of embodiment 167, wherein, during contact, the tip of the needle engages a recess defined in the piston.
169. The liquid dispensing system of embodiment 166, wherein, after the plunger contacts the piston, at least a portion of the plunger becomes movably disposed in the cartridge.
170. A system for dispensing a liquid or gas, comprising:

a dispenser comprising a hollow body and a plunger movably disposed in the body, the body having a grip member; and

a plurality of caps, each cap defining a dispensing opening at one end thereof and having a membrane disposed therein, wherein each cap is removably and interchangeably coupleable to one end of the body.
171. The system of embodiment 170, wherein movement of the plunger causes the plunger to pierce the membrane and create an opening in the membrane for liquid to exit the dispenser.
172. The system of embodiment 170, wherein each cap is coupleable to the body via a bayonet-style fitting.
173. The system of embodiment 170, wherein each cap comprises a latch arm for coupling to the body.
174. The system of embodiment 173, wherein as the cap couples to the body, the latch arm engages an opening defined in the body.
175. The system of embodiment 173, wherein the latch arm comprises a plurality of latch arms.
176. The system of embodiment 170, wherein the cap comprises a thin cylindrical portion and a thick cylindrical portion, the dispensing opening defined at one end of the thin cylindrical portion.
177. The system of embodiment 170, further comprising a cartridge disposed in each cap, the membrane disposed at one end of the cartridge.
178. The system of embodiment 177, further comprising a piston movably disposed in the cartridge.
179. The system of embodiment 178, wherein movement of the piston pierces the membrane and creates an opening in the membrane for liquid to exit the dispenser.
180. The system of embodiment 178, wherein the piston comprises a piercing member for piercing the membrane.
181. The system of embodiment 180, wherein the piercing member comprises a plurality of channels defined therein.
182. The system of embodiment 181, wherein, as the piercing member pierces the membrane, liquid flows along the plurality of channels and exits the dispenser.
183. The system of embodiment 178, further comprising a sealing member disposed intermediate the piston and the cartridge.
184. The system of embodiment 183, wherein the sealing member is molded onto the piston.
185. The system of embodiment 178, wherein, during use, the plunger moves in a dispensing direction and contacts the piston.
186. The system of embodiment 185, wherein, after the plunger contacts the piston, the plunger and piston move substantially concomitantly in the dispensing direction.
187. The system of embodiment 185, wherein the plunger includes a needle that contacts the piston.
188. The system of embodiment 187, wherein, during contact, the tip of the needle engages a recess defined in the piston.
189. The system of embodiment 185, wherein, after the plunger contacts the piston, at least a portion of the plunger becomes movably disposed in the cartridge.
190. The system of embodiment 170, wherein, after use, the cap can be decoupled from the body.
191. The system of embodiment 190, wherein each cap comprises a wing that extends radially outward therefrom.
192. The system of embodiment 191, wherein the wing comprises a plurality of wings.
193. The system of embodiment 191, wherein the wing can be twisted for decoupling the cap from the body.
194. The system of embodiment 170, further comprising a finger-actuable latch movably coupled to the body and positioned near the plunger, wherein movement of the latch releases the plunger for movement.
195. A cap for coupling to a liquid dispenser, comprising:

a liquid-tight housing for containing a liquid, the housing defining a dispensing opening at one end thereof and defining a connector for coupling to the dispenser; and

a plunger movably disposed in the housing, wherein movement of the plunger pierces a membrane in the cap and creates an opening in the membrane for liquid to exit the cap.
196. The cap of embodiment 195, wherein the membrane is disposed adjacent to the dispensing opening.
197. The cap of embodiment 195, wherein the plunger comprises a piercing member for piercing the membrane.
198. The cap of embodiment 195, further comprising a recess defined in one end of the plunger.
199. The cap of embodiment 195, further comprising a sealing member disposed between the plunger and the housing.
200. The cap of embodiment 199, wherein the sealing member is molded onto the plunger.
201. The cap of embodiment 195, further comprising a foil seal disposed adjacent to the connector.
202. The cap of embodiment 195, wherein the connector comprises a latch arm.
203. The cap of embodiment 195, further comprising a plurality of wings extending from the housing.
204. The cap of embodiment 195, further comprising a dispensing channel defined within the housing, the channel extending from the membrane to the dispensing opening.

What is claimed is:

1. A liquid dispenser, comprising:
a hollow body having a grip member;
a cap coupled to one end of the body and defining a dispensing opening;
a cartridge disposed in the cap, the cartridge having a membrane; and
a plunger movably disposed in the body, wherein movement of the plunger pierces the membrane and creates an aperture in the membrane for liquid to exit the dispenser.

2. The liquid dispenser of claim 1, wherein the cartridge is removably disposed in the cap.

3. The liquid dispenser of claim 1, further comprising a latch movably coupled to the body and positioned near the plunger, wherein movement of the latch releases the plunger from a locked position.

4. The liquid dispenser of claim 1, wherein the cap couples to the body via a bayonet-style fitting.

5. The liquid dispenser of claim 1, wherein the cap comprises a plurality of latch arms for engaging features defined in the body.

6. The liquid dispenser of claim 1, wherein the cartridge comprises a housing with the membrane disposed at one end thereof.

7. The liquid dispenser of claim 1, further comprising a piston movably disposed in the cartridge.

8. The liquid dispenser of claim 7, wherein movement of the piston pierces the membrane and creates an opening the aperture in the membrane.

9. The liquid dispenser of claim 7, wherein the piston comprises a piercing member for piercing the membrane.

10. The liquid dispenser of claim 9, wherein the piercing member comprises a plurality of channels defined therein.

11. The liquid dispenser of claim 9, wherein the piercing member comprises a tip pointed toward the membrane.

12. The liquid dispenser of claim 7, further comprising a sealing member disposed between the piston and the cartridge.

13. The liquid dispenser of claim 12, wherein the sealing member is secured to the plunger.

14. The liquid dispenser of claim 12, wherein the sealing member comprises an o-ring.

15. The liquid dispenser of claim 12, further comprising a reservoir defined by the membrane, the sealing member, and the cartridge.

16. The liquid dispenser of claim 15, wherein the reservoir comprises liquid and gas.

17. The liquid dispenser of claim 16, wherein the liquid comprises a pesticide for treating animals.

18. The liquid dispenser of claim 16, wherein, as the piston moves in a direction towards the membrane, the gas in the reservoir is compressed.

19. The liquid dispenser of claim 7, wherein, during use, the plunger moves in a dispensing direction and contacts the piston.

20. The liquid dispenser of claim 19, wherein, after the plunger contacts the piston, the plunger and piston move substantially together in the dispensing direction.

21. The liquid dispenser of claim 19, wherein the plunger includes a needle that contacts the piston.

22. The liquid dispenser of claim 21, wherein, during contact, the tip of the needle engages a recess defined in the piston.

23. The liquid dispenser of claim 19, wherein, after the plunger contacts the piston, at least a portion of the plunger becomes movably disposed in the cartridge.

24. The liquid dispenser of claim 1, wherein the dispensing aperture is defined at one longitudinal end of the cap and a seal is disposed at the other longitudinal end thereof.

25. The liquid dispenser of claim 24, wherein as the cap is coupled to the body, the plunger pierces the seal.

26. A system for dispensing a liquid, comprising:
a dispenser comprising a hollow body and a plunger movably disposed in the body, the body having a grip member; and
a plurality of caps, each cap defining a dispensing opening at one end thereof and having a membrane disposed therein, each cap being removably and interchangeably coupleable to one end of the body.

27. The system of claim 26, wherein movement of the plunger creates an aperture in the membrane for liquid to exit the dispenser via the dispensing opening.

28. The system of claim 26, further comprising a finger-actuable latch movably coupled to the body, wherein movement of the latch releases the plunger from a fixed position.

29. The system of claim 26, further comprising a cartridge disposed in each cap, the membrane being disposed at one end of the cartridge.

30. The system of claim 29, further comprising a piston movably disposed in the cartridge.

31. The system of claim 30, wherein movement of the piston pierces the membrane and creates the aperture in the membrane.

32. The system of claim 30, wherein, during use, the plunger moves in a dispensing direction and contacts the piston.

33. The system of claim 32, wherein, after the plunger contacts the piston, the plunger and piston move substantially together in the dispensing direction.

34. A method of dispensing liquid from a dispenser onto an animal, the dispenser being of the type having a body, a chamber containing the liquid to be dispensed, and a moveable plunger, the method comprising:
placing a tip of the dispenser on or near the skin of the animal;
depressing the plunger and thereby compressing gas located in the chamber, wherein the depressing causes a piercing member to pierce a membrane and form an aperture in the membrane; and
dispensing at least some of the liquid through an opening of the dispenser onto the animal.

35. The method of claim 34, further comprising unlocking the plunger before the depressing step.

36. The method of claim 35, wherein the unlocking comprises disengaging a latch from the plunger.

37. The method of claim 36, further comprising using the same finger or thumb for the depressing step and the unlocking step.

38. The method of claim 35, wherein one hand of a user performs the depressing step and the unlocking step while the user's other hand holds the animal.

39. The method of claim 34, further comprising locking the plunger in place after it is fully depressed.

40. The method of claim 34, further comprising providing tactile feedback to a user during the depressing step, the tactile feedback comprising initial resistance against the depression and a click or snap perceptible to the user when the plunger is fully depressed.

41. The method of claim 34, further comprising substantially depleting the liquid from the dispenser.

42. The method of claim 34, wherein an entire dose is dispensed in a single stroke of the plunger.

43. The method of claim 34, wherein the piercing of the membrane comprises the plunger pushing the piercing member through the membrane.

44. The method of claim 43, wherein the piercing member moves in substantially the same direction as the plunger.

45. The method of claim 43, wherein as the piercing member pierces the membrane, at least some of the liquid flows through the aperture along a channel defined in the piercing member.

46. The method of claim 34, further comprising dispensing the liquid from the dispenser at a high velocity.

47. A method of dispensing a liquid from a dispenser onto the skin of an animal, the dispenser being of the type having a body, a dispensing opening, a chamber containing the liquid, and a moveable plunger, the method comprising:
(a) gripping the dispenser with one hand;
(b) placing the opening of the dispenser on or near the skin of the animal;
(c) unlocking the dispenser with the one hand, thereby freeing the plunger; and
(d) depressing the plunger with the one hand, thereby dispensing at least some of the liquid through the opening.

48. The method of claim 47, wherein step (c) comprises disengaging a latch from the plunger.

49. The method of claim 47, further comprising using the same finger or thumb of the one hand during steps (c) and (d).

50. The method of claim 47, further comprising the user using a second hand to hold the animal during at least steps (b), (c) and (d).

51. The method of claim 47, wherein the depressing of the plunger pierces a first membrane and compels the liquid through the pierced first membrane and out of the opening.

52. The method of claim 51, wherein the dispenser has a second membrane disposed between the plunger and the liquid, the liquid dispenser has a piston disposed between the first and second membranes, and wherein the depressing of the plunger causes the piston to perform the piercing of the first membrane.

53. The method of claim 47, further comprising locking the plunger in place after it is fully depressed.

54. The method of claim 47, further comprising providing tactile feedback to the user during step (d), the tactile feedback including initial resistance against the depression, and including a click or snap perceptible to the user when the plunger is fully depressed.

55. The method of claim 54, wherein the tactile feedback further comprises pneumatic cushioning.

56. The method of claim 47, further comprising substantially depleting the liquid from the dispenser.

57. The method of claim 47, wherein an entire dose is dispensed in a single stroke of the plunger.
